(19) United States
(12) Patent Application Publication
(10) Pub. No.: US 2026/0281838 A1
(43) Pub. Date: Sep. 17, 2026

(54) METHOD, USER EQUIPMENT AND ACCESS NETWORK NODE

(71) Applicant: NEC Corporation, Tokyo (JP)

(72) Inventors: Yuhua CHEN, London (GB); Xueiong WANG, Guildford (GB); Hisashi FUTAKI, Tokyo (JP)

(73) Assignee: NEC Corporation, Tokyo (JP)

(21) Appl. No.: 19/168,917

(22) PCT Filed: Mar. 28, 2024
(86) PCT No.: PCT/JP2024/012877

§ 371 Date: Sep. 25, 2025

(30) Foreign Application Priority Data
Apr. 5, 2023 (GB) 2305109.7

(51) Int. Cl. H04W 36/00; H04W 36/36

(52) U.S. Cl. CPC H04W 36/00725; H04W 36/362

(57) ABSTRACT

A communication system is disclosed in which a candidate access network node, performing an initial access procedure with an access network node, without using a random access channel, at a configured timing.

### TECHNICAL FIELD

The present disclosure relates to a wireless communication system and devices thereof operating according to the 3rd Generation Partnership Project (3GPP) standards or equivalents or derivatives thereof.

### BACKGROUND ART

The disclosure has particular but not exclusive relevance to improvements relating to mobility procedures in which initial access to a new cell using a random access channel is avoided taking place in so-called ‘5G’ (or ‘Next Generation (NG)’ or ‘New Radio’ (NR)) systems and beyond, and in particular in (but not limited to) the context of Non-Terrestrial Networks (NTN).

Earlier developments of the 3GPP standards were referred to as the Long-Term Evolution (LTE) of Evolved Packet Core (EPC) network and Evolved UMTS Terrestrial Radio Access Network (E-UTRAN), also commonly referred as ‘4G’. More recently, the term ‘5G’ and ‘new radio’ (NR) has started to be used to refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, and gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term access network node, RAN node or base station to refer to any such access nodes.

For simplicity, the present application will use the term mobile device, user device, or UE to refer to any communication device that is able to connect to the core network via one or more base stations. Although the present application may refer to mobile devices in the description, it will be appreciated that the technology described can be implemented on any communication devices (mobile and/or generally stationary) that can connect to a communications network for sending/receiving data, regardless of whether such communication devices are controlled by human input or software instructions stored in memory.

In the current 5G architecture, the gNB structure may be split into two or more parts. In some RAN implementations there are two parts, known as the Central Unit (CU or gNB-CU)-sometimes referred to as a ‘control unit’- and the Distributed Unit (DU or gNB-DU), connected by an F1 interface. This enables the use of a ‘split’ architecture in which the typically ‘higher’ CU layers (for example, but not necessarily or exclusively, Packet Data Convergence Protocol (PDCP) and Radio Resource Control (RRC) layers) and the, ‘lower’ DU layers (for example, but not necessarily or exclusively, Radio Link Control (RLC), Media Access Control (MAC), and Physical (PHY) layers) are separated between a particular CU, and one or more DUs that are connected to and controlled by that CU via the F1 interface. Thus, for example, the higher layer CU functionality for a number of gNBs may be implemented centrally (for example, by a single processing unit, or in a cloud-based or virtualised system), whilst retaining the lower layer DU functionality locally separately for each gNB.

3GPP is also working with the satellite communication industry to specify an integrated satellite and terrestrial network infrastructure in the context of 5G. This is referred to as non-terrestrial networks (NTN) which term refers to networks, or segments of networks, using an airborne or spaceborne vehicle for transmission of data and control signalling. Satellites refer to spaceborne vehicles in Low Earth Orbits (LEO), Medium Earth Orbits (MEO), Geostationary Earth Orbit (GEO) or in Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS—all operating quasi-stationary at an altitude typically between 8 and 50 km.

3GPP Technical Report (TR) 38.811 is a study on New Radio to support such on-terrestrial networks. The study includes, amongst other things, NTN deployment scenarios and related system parameters (such as architecture, altitude, orbit etc.) and a description of adaptation of the 3GPP channel models for non-terrestrial networks (propagation conditions, mobility, etc.). Non-terrestrial networks are expected to:
help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere; especially for critical communications, future railway/maritime/aeronautical communications; and
enable 5G network scalability through the provision of efficient multicast/broadcast resources for data delivery towards the network edges or even directly to the user equipment.

Non-Terrestrial Network access typically features the following elements (amongst others):
NTN Terminal: This may refer to the 3GPP UE or to a UE specific to the satellite system in the case that the satellite does not serve directly 3GPP UEs;
A service link which refers to the radio link between the user equipment and the space/airborne platform (which may be in addition to a radio link with a terrestrial based RAN);
A space or an airborne platform;
Gateways that connect the satellite or aerial access network to the core network. It will be appreciated that gateways will mostly likely be collocated with a base station (e.g. a gNB);
Feeder links which refer to the radio links between the Gateways and the space/airborne platform.

Satellite or aerial vehicles typically generate several satellite beams over a given area. The beams have a typically elliptic footprint on the surface of the earth. The beam footprint may be moving over the earth with the satellite or the aerial vehicle motion on its orbit. Alternatively, the beam footprint may be earth fixed (albeit temporarily), in such case some beam pointing mechanisms (mechanical or electronic steering feature) may be used to compensate for the satellite or the aerial vehicle motion. There are different options for beam identification purposes. In one option multiple (nearby/neighbouring) satellite beams may have the same associated physical cell ID (PCI) and hence the PCI can remain unchanged as UE 3 moves from beam-to-beam of the set of beams sharing a PCI. Alternatively, there may be a one-to-one relationship between the PCIs and the satellite beams (at least within a particular satellite's coverage area comprising multiple beams).

The coverage in 5G is primarily beam-based rather than cell based. There is no cell-level reference channel from where the coverage of the cell could be measured. Instead, each cell has one or more so-called synchronization signal block (SSB) beams (which are different to satellite or NTN beams). SSB beams form a matrix of beams covering an entire cell area. Each SSB beam carries an SSB comprising a primary synchronization signal (PSS), secondary synchronization signal (SSS), and physical broadcast channel (PBCH).

The UE searches for and performs measurements on the SSB beams (e.g. of the synchronization signal reference signal received power, ‘SS-RSRP’, synchronization signal reference signal received quality, ‘SS-RSRQ’, and/or the synchronization signal to noise or interference ratio, ‘SS-SINR’). The UE maintains a set of candidate beams which may contain beams from multiple cells. A PCI and beam ID (or SSB index) thus distinguish the SSB beams from each other. Effectively, therefore, the SSB beams are like mini cells which may be within a larger cell. Once a UE has detected and selected a cell (and/or an SSB beam in the case of 5G) it may attempt to access that cell and/or SSB beam using an initial radio resource control (RRC) connection setup procedure comprising a random access procedure.

For example, once a UE has detected and selected a cell (and/or a beam in the case of 5G) it may attempt to access that cell and/or beam using an initial radio resource control (RRC) connection setup procedure comprising a random access procedure that typically involves four distinct steps. In the case of 5G prior to attempting initial access the UE may perform transmission of a preamble to the network (e.g. a base station such as a gNB) over a physical random access channel (PRACH/RACH) for initiating a random access procedure (also referred to as a RACH procedure or simply RACH) for obtaining synchronization in the uplink (UL). This step is often referred to as PRACH transmission or simply transmission of message 1 (Msg1). In response, the network responds with a random access response (RAR). The RAR indicates reception of the preamble and includes: a timing-alignment (TA) command for adjusting the transmission timing of the UE based on the timing of the received preamble; an uplink grant field indicating the resources to be used in the uplink for a physical uplink shared channel (PUSCH); a frequency hopping flag to indicate whether the UE is to transmit on the PUSCH with or without frequency; a modulation and coding scheme (MCS) field from which the UE can determine the MCS for the PUSCH transmission; and a transmit power control (TPC) command value for setting the power of the PUSCH transmission. The RAR transmission step is often referred to as message 2 (Msg2) transmission. The UE then sends a third message (message 3 or ‘Msg3’) to the network over the physical uplink shared channel (PUSCH) based on the information in the RAR. The specific message sent by the UE in this step, and the content of the message, depends on the context in which the random access procedure is being used. In the example of initial radio RRC connection setup, however, Msg3 typically comprises an RRC Setup request or similar message carrying a temporary randomly generated UE identifier. The network responds with a fourth message (message 4 or ‘Msg4’) which carries the randomly generated UE identifier received in Msg3 for contention purposes to resolve any collisions between different UEs using the same preamble sequence. When successful, Msg4 also transfers the UE to a connected state.

A similar random access procedure may also be used in other contexts within NR including, for example, handover, connection reestablishment, requesting UL scheduling where no dedicated resource for a scheduling-request has been configured for the UE, etc.

A so-called two-step random access procedure has also been developed (in addition to the above described four-step random access procedure). The two-step random access is mainly intended for supporting (Ultra) Low Latency Communications, 10 ms control plane latency, fast handover, efficient channel access in unlicensed spectrum, and transmission of small data packets, amongst others. However, it may also apply to large cells such as non-terrestrial cells. The main difference is that whilst the four-step random access procedure requires two round-trip cycles between the UE and the base station, the two-step random access procedure aims to reduce latency and control-signalling overhead by using a single round trip cycle between the UE and the base station. Effectively, this is achieved by combining the UE's PRACH preamble (Msg1) transmission and the scheduled PUSCH transmission (Msg3) into a single message (referred to as ‘MsgA’). Similarly, the random access response (RAR/Msg2) from the base station to UE and the contention resolution message (Msg4) are combined in the two-step random access procedure (and referred to as ‘MsgB’).

As those skilled in the art will appreciate, while a contention based PRACH procedure is described, a non-contention based (or ‘contention free’) procedure may also be used in which a dedicated preamble is assigned by the base station to the UE.

In addition to the RACH-based initial access procedures described above, a so called RACH-less access procedure was introduced, in the context of handover procedures during the development of later releases of the LTE standards, also with a view to providing reduced latency. RACH-less based handover provides reductions in the data connectivity interruption time at each handover as it removes the need for performing random access when first accessing the target cell, and hence reduces overall handover execution time.

FIG. 1 is a simplified sequence diagram illustrating a handover procedure involving RACH-less initial access to a target cell.

As seen in FIG. 1, before handover commences a RAN node 5A-1 (e.g., base station) is serving and communicating with a UE 3 at S102. In the RACH-less handover procedure (as in other handover procedures) a handover preparation phase S110 commences when the serving RAN node 5A-1 (operating as a source RAN node 5A-1) initially decides to initiate a handover at S114 based on measurement reporting by a UE 3 as S112 (e.g., a measurement report triggered by a particular measurement reporting event, or periodically, or the like). The source RAN node 5A-1 initiates preparation of a target RAN node 5A-2 (e.g., base station) for handover by sending a handover request message at S116.

Assuming the target RAN node 5A-2 decides to allow the handover request (e.g., based on appropriate admission control), the target RAN node 5A-2 prepares handover with layer 1/layer 2 (L1/L2) and sends a handover request acknowledgement message (e.g., ‘Handover Request Acknowledge’) to the source RAN node 5A-1 at S118. This handover request acknowledgement message includes an RRC message generated by the target RAN node 5A-2 for instructing modification/reconfiguration of the UE's RRC connection for the purposes of handover (e.g., an RRCConnectionReconfiguration message). The RRC reconfiguration message is provided in a so-called ‘transparent’ container to be sent to the UE to perform the handover (in information element that is not read or modified by the recipient node but is, instead forwarded without modification). The container includes a new cell radio network temporary identifier (C-RNTI), target base station security algorithm identifiers for the selected security algorithms, and possibly some other parameters i.e. access parameters, SIBs, etc.

This RRC reconfiguration message includes mobility control information parameters relevant for network-controlled mobility (handover). For RACH-less handover, this mobility control information includes an indication that the initial access to the target should be RACH-less (e.g., a RACH-skip information element (IE) to indicate that RACH should be skipped).

The mobility control information also includes an indication of a target timing advance (e.g. in a ‘targetTA’ IE) that refers to the timing adjustment indication, indicating a value of a timing offset (N_{TA}) between uplink and downlink radio frames for the UE 3 to use for the target a timing advance group (TAG) (e.g., a primary TAG (PTAG) in the case of a handover or a primary secondary TAG (PSTAG) in the case of a secondary cell group (SCG) change).

The mobility control information may also, optionally, include a pre-allocated uplink grant (i.e., a ‘configured grant’ (CG)) for use in a RACH-less initial access in a target cell of the target RAN node 5A-2. This may, for example, be provided as uplink configuration information (e.g., in a ‘ul-ConfigInfo’ IE or the like) indicating the number of configured hybrid automatic repeat request (HARQ) processes for the pre-allocated uplink grants, the scheduling interval and the startoffset in subframe with which the UE 3 may determine the periodical uplink transmission occasions, and the frequency and time resources of the target cell to be used for the uplink transmission.

The source RAN node 5A-1 initiates a handover execution phase by S120 sending the RRC reconfiguration message (including the mobility control information) to the UE 3 at S122. The UE 3 receives the RRC reconfiguration message with necessary parameters (i.e. new C-RNTI, target base station security algorithm identifiers, target base station SIBs, etc.) and is thus commanded by the source RAN node 5A-1 to perform the handover. As mentioned above, for RACH-less handover, the RRC reconfiguration message includes timing adjustment indication and optionally the pre-allocated uplink grants for accessing the target base station. For RACH-less handover the UE 3 does not need to delay handover execution for delivering HARQ/ARQ responses to source RAN node 5A-1.

As RACH-less handover has been configured (e.g., by an RRC Reconfiguration message that includes the RACH-skip), the UE 3 configures lower layers to apply the RACH-skip for the target master cell group (MCG). The UE 3 performs synchronisation to target RAN node 5A-2 at S126 based on the timing adjustment indication. To facilitate this, a MAC entity at the UE has a configurable timer (e.g. timeAlignmentTimer” per TAG. The timer is used to control how long the MAC entity considers the serving cells belonging to the associated TAG to be uplink time aligned. When the UE 3 (and hence the MAC entity) is configured to skip the RACH, the MAC entity applies the timing advance value indicated by the timing adjustment indication for the primary TAG and starts the timer associated with this TAG.

The UE 3 derives target RAN node 5A-2 specific keys and configures the selected security algorithms to be used in the target cell.

After receiving the RRC Reconfiguration message, the UE 3 will attempt to access a primary cell (PCell) of the target RAN node 5A-2 at the first available physical uplink shared channel (PUSCH) occasion. Where a pre-allocated uplink grant has been provided in the uplink configuration information this defines the first available PUSCH occasion. Otherwise, where a pre-allocated uplink grant is not included, the UE 3 will then monitor the physical downlink control channel (PDCCH) of the target base station to receive an uplink grant (i.e., a ‘dynamic’ grant) in order to perform initial access without using a RACH procedure. Thus, the UE 3 receives the (‘dynamic’) uplink grant via the PDCCH of the target cell (as seen at S128). The UE 3 uses the first available uplink grant after synchronization to the target cell.

To confirm the handover, upon successful completion, when the UE 3 has an uplink grant (pre-allocated periodical or received in the PDCCH), the UE 3 sends an RRC reconfiguration complete message (e.g., an RRCConnectionReconfiguration Complete message) to the target RAN node 5A-2, at S130, using the uplink grant (pre-allocated periodical or received in the PDCCH). The RRC reconfiguration complete message includes the C-RNTI (along with an uplink buffer status report, and/or uplink data, whenever possible). The target RAN node 5A-2 verifies the C-RNTI sent in the RRC reconfiguration complete message. The target RAN node 5A-2 can now begin sending data to the UE 3 after scheduling appropriate downlink resources using the PDCCH as seen at S132.

The handover procedure is completed for the UE 3 when the UE 3 receives a UE contention resolution identity MAC control element (MAC CE) from the target RAN node 5A-2 (at S134) or the UE 3 receives a PDCCH addressed to its C-RNTI from the target RAN node 5A-2 after sending the initial uplink transmission.

The UE 3 can then release any pre-allocated uplink grant resources (if configured) at S136.

The RACH-less access procedure provides a relatively brief time window between the completion of handover preparation and the completion of handover execution. Where an uplink grant to be used for the first uplink message (i.e., the RRC message indicating handover completion) is a ‘configured’ (periodical) grant pre-allocated by the target RAN node, then this time window is essentially the time period starting from the uplink resources being reserved, during which the uplink resources are used, until those uplink resources are released. Where an uplink grant to be used for the first uplink message are dynamic scheduled, then this time window is essentially the time period for scheduling using, and blind decoding, the PDDCH.

### CITATION LIST

### Patent Literature

PTL 1: EP4109965A1
PTL 2: US2018/0049079A1
PTL 3: US2018/0332507A1
PTL 4: US2021/0120551A1

### Non Patent Literature

NPL 1: The ‘NGMN 5G White Paper’ V1.0 by the Next Generation Mobile Networks (NGMN) Alliance, available from https://www.ngmn.org/5g-white-paper.html

### SUMMARY OF INVENTION

### Technical Problem

Recently it has been agreed that RACH-less handover should be supported for NTN (e.g., for NR and beyond). In this context, it is the current consensus that RACH-less handover for NTN will be a layer 3 (L3) mobility procedure that is similar to the procedure of FIG. 1 as a baseline. RACH-less handover in NTN is more complex and difficult to implement in the context of NTN, however, because of the complexity of acquiring an accurate timing advance for the moving NTN target cell without using the conventional random access procedure. It is envisaged that, for NTN RACH-less handover, the network will indicate (implicitly or explicitly) whether the timing advance (N_{TA}) for the target cell will be identical to that of the source cell or will be explicitly provided somehow by the network. However, precisely how the initial timing advance will be acquired for the target cell remains to be defined. Dynamic grant from the target cell for a RACH-less PUSCH transmission will also be supported to reduce random access congestion in the target cell. In the context of NTN, discussion of RACH-less handover has been focused on scenarios in which the same feeder link/gateway is used before and after handover. The question of whether RACH-less handover should be limited to such handover scenarios, including the same feeder link/gateway, is open to debate.

However, whilst introducing a RACH-less L3 mobility procedure based on the procedure of FIG. 1 as a baseline may provide some benefit in the context of some handovers in NTN scenarios, the benefit may be relatively limited because such network centric handover procedures may not be as widely used as expected.

Moreover, in the event of a change of service link/satellite (service link switch/satellite switch) arising from satellite movement in which the feeder link of the new satellite providing the new service link is to the same base station, the physical RAN hardware (i.e., implementing the base station) via which the UE 3 connects to the wider network, and the radio resources used, will not change. Nevertheless, as there has been a change in the satellite that relays the UE's communication to and from the network, it is generally considered preferable to change the PCI for the cell that is serving the UE 3. If the PCI changes, however, from perspective of the UE 3 there are two different cells (one appearing and the other disappearing). Consequently, the UE 3 will execute L3 handover or RRC re-establishment to connect to the new cell. This would result in inefficiencies in terms of the amount of signalling and the delay caused by the service interruption. While a proposal has been suggested in which PCI is not changed and hence L3 handover is not triggered, this is also not ideal because the ‘soft’ switch required in this case is, itself, not efficient.

### Solution to Problem

The disclosure aims to provide one or more apparatus and/or one or more associated methods that at least partially addresses or contributes to addressing one or more of the above issues.

In particular, the inventors have realised that, whilst introducing a RACH-less L3 mobility procedure based on the procedure of FIG. 1 as a baseline may provide some benefit in the context of some handovers in NTN scenarios, the benefit may be relatively limited because more UE centric handover procedures may be more prevalent-especially in (but not limited to) the context of NTN.

Specifically, considering the very frequent handovers (especially in the context of earth moving cell scenarios) and the increasing number of UEs to handover at the same time (in quasi-earth fixed cell scenario), it is likely that use of a more UE centric handover procedure, such as a so-called conditional handover (CHO), will become more desirable. A CHO is a handover that is not executed until the UE being handed over (rather than the network) determines that one or more handover execution conditions have been met. Once one or more handover execution conditions have been met the UE then executes handover. The UE starts evaluating one or more execution conditions upon receiving a CHO configuration from the network, and then stops evaluating one or more execution conditions once a handover has been executed.

The inventors have understood that CHO is likely to become a much more important and fundamental feature in the context of 5G (and beyond) systems and, in particular, for NTN scenarios. This is because, effectively, with CHO the measurement reporting and subsequent handover command signalling that would otherwise be required for determining that handover conditions have been met and triggering handover execution can be avoided. Instead, the execution condition and RRC configuration are pre-configured (possibly for multiple different target cells)—a potentially long time before the time that handover needs to be executed. Such CHO also has the potential to reduce the delay associated with handover interruption, which could be longer in an NTN scenario than in a conventional terrestrial network scenario.

However, while introducing RACH-less access in the context of CHO is desirable—especially for NTN scenarios—in general implementing it is seen as not being trivial, and there is a general perception against doing so. This is because for CHO, it is not certain whether—or when—a handover to any particular target cell for which handover has been pre-prepared will actually occur. It is, therefore, difficult for a target RAN node (base station) to decide if, and when, to start sending any dynamic grant for a target cell to the UE. Moreover, if a pre-allocated grant is used, the target RAN node will not know if the pre-allocated grant will ever be used and, if so when it will be used in real time. Any such pre-allocated grant might, therefore, wasted.

In one aspect there is provided method performed by a candidate access network node, the method comprising: receiving, from a serving access network node, at least one message for requesting preparation for a conditional handover, for a user equipment (UE), from a serving cell of the serving access network node, to at least one candidate cell of the candidate access network node, wherein the at least one candidate cell is a candidate to be a target cell for the conditional handover and the candidate access network node is a candidate to be a target access network node for the conditional handover; and transmitting, to the serving access network node, at least one message including configuration information for the conditional handover to the at least one candidate cell; wherein the configuration information includes information indicating that, in a case where the UE performs an access procedure to access the at least one candidate cell, the access procedure is to be performed without using a random access channel.

The method may further comprise, scheduling at least one resource for uplink communication for use by the UE in the access procedure; and in a case where the UE performs the access procedure to access the at least one candidate cell: receiving, from the UE, an uplink message that is sent using the at least one resource for uplink communication that has been scheduled by the candidate access network node.

The uplink message may indicate that the conditional handover to the at least one candidate cell has completed at the UE.

The method may further comprise receiving, from the serving access network node, a notification that a conditional handover to the at least one candidate cell has been, or will be, initiated; and receiving, based on the notification, the uplink message.

The method may further comprise receiving, based on the notification, comprises dynamically scheduling the at least one resource for uplink communication and receiving the uplink message using the at least one resource for uplink communication.

The method may further comprise pre-configuring at least one resource for uplink communication prior to reception of the notification, and the receiving, based on the notification, may comprise decoding, based on the notification, the uplink message.

The scheduling may comprise dynamic scheduling of the at least one resource for uplink communication.

The method may further comprise receiving, from the serving access network node, time information indicating a predicted time that the UE will leave the serving cell and/or a predicted time that the UE will enter the at least one candidate cell, wherein timing of the dynamic scheduling is based on the time information.

The scheduling may comprise pre-configuring the at least one resource for uplink communication as a configured grant.

The configured grant may be configured specifically for use by the UE for uplink communication in the access procedure for the conditional handover.

The configured grant may be configured for contention based uplink communication.

The configuration information for the conditional handover may include scheduling information for configuring the configured grant.

The configuration information for the conditional handover may include time information for configuring a time period during which the configured grant is valid.

The time information may be configured for configuring the time period during which the configured grant is valid relative to a further time period for a time based condition for triggering the conditional handover.

The method may further comprise receiving, from the serving access network node, further time information indicating a predicted time that the UE will leave the serving cell and/or a predicted time that the UE will enter the at least one candidate cell, wherein the time information is based on the further time information.

In another aspect there is provided a method performed by a serving access network node, the method comprising: transmitting, to at least one candidate access network node, at least one message for requesting preparation for a conditional handover, for a user equipment (UE), from a serving cell of the serving access network node, to at least one candidate cell of the candidate access network node, wherein the at least one candidate cell is a candidate to be a target cell for the conditional handover and the at least one candidate access network node is a candidate to be a target access network node for the conditional handover; receiving, from the target access network node, at least one message including configuration information for the conditional handover to the at least one candidate cell; and transmitting, to the UE, the configuration information for the conditional handover; wherein the configuration information includes information indicating that, in a case where the UE performs an access procedure to access the at least one candidate cell, the access procedure is to be performed without using a random access channel.

The method may further comprise receiving, from the UE, a first notification that a conditional handover to the at least one candidate cell has been, or will be, initiated; and transmitting, to the candidate access network node, a second notification that a conditional handover to the at least one candidate cell has been, or will be, initiated.

The method may further comprise receiving, from the UE, time information indicating a predicted time that the UE will leave the serving cell and/or a predicted time that the UE will enter the at least one candidate cell, and transmitting the time information to the at least one candidate access network node.

In another aspect there is provided method performed by a user equipment (UE), the method comprising: receiving, from a serving access network node, configuration information for a conditional handover from a serving cell of the serving access network node, to at least one candidate cell of at least one candidate access network node, wherein the at least one candidate cell is a candidate to be a target cell for the conditional handover and the at least one candidate access network node is a candidate to be a target access network node for the conditional handover; wherein the configuration information includes information indicating that, in a case where the UE performs an access procedure to access the at least one candidate cell, the access procedure is to be performed without using a random access channel.

The method may further comprise performing the access procedure to access a specific candidate cell of a specific candidate access network node, the access procedure including transmitting, to the specific candidate access network node, an uplink message that is sent using at least one resource for uplink communication that has been scheduled by the specific candidate access network node.

The method may further comprise transmitting, to the serving access network node, a notification that a conditional handover to the at least one candidate cell has been, or will be, initiated.

The method may further comprise transmitting, to the serving access network node, time information indicating a predicted time that the UE will leave the serving cell and/or a predicted time that the UE will enter the at least one candidate cell.

In another aspect there is provided method performed by a user equipment (UE), the method comprising: transmitting, to an access network node as part of an initial access procedure that does not involve use of a random access channel, an initial uplink message using at least one uplink resource, wherein the at least one uplink resource is a resource configured for contention based uplink communication; in a case where a contention resolution indication is not received from the access network node within a first time period, resending the initial uplink message to the access network node using the at least one uplink resource; in a case where a contention resolution indication is received from the access network node within the first time period, treating the initial access procedure as successfully completed in further communication with the access network node; and in a case where a contention resolution indication is not received from the access network node within a second time period, treating the initial access procedure as not having been successfully completed.

The method may further comprise in the case where a contention resolution indication is not received from the access network node within the first time period and has still not been received within a third time period starting from the end of the first period, repeating the resending of the initial uplink message to the access network node using the at least one uplink resource.

The method may further comprise, in the case where a contention resolution indication is not received from the access network node within the second time period, performing a fall-back initial access procedure using a random access channel.

In a case where a contention resolution indication is received from the access network node, the contention resolution indication my include at least some information that was included in the uplink message.

In case where a contention resolution indication is received from the access network node, the contention resolution indication may be provided using a media access control (MAC) control element (CE).

In a case where a contention resolution indication is received from the access network node, the contention resolution indication may be provided using downlink control information (DCI).

The DCI may be encoded using a radio network temporary identifier (RNTI) associated with the UE.

In another aspect there is provided a method performed by an access network node, the method comprising: receiving, from a user equipment (UE) as part of an initial access procedure that does not involve use of a random access channel, an initial uplink message using at least one uplink resource, wherein the at least one uplink resource is a resource configured for contention based uplink communication; transmitting a contention resolution indication to the UE; and treating the initial access procedure as successfully completed in further communication with the UE.

In another aspect there is provided a method performed by a user equipment (UE), the method comprising: communicating with an access network node, in a first cell provided by the access network node, via a first non-terrestrial platform, based on a connection configuration; receiving from the access network node, via the first non-terrestrial platform, cell related information: that will apply in respect of the first cell when the first cell is provided by the access network node via a second non-terrestrial platform following a change of non-terrestrial platform; or that will apply in respect of a second cell provided by the access network node via the second non-terrestrial platform that replaces the first cell following the change of non-terrestrial platform; and following the change of non-terrestrial platform, preparing for communication via the second non-terrestrial platform based on the cell related information; and continuing communication with the access network node, based on the connection configuration, in the first cell, or in the second cell in a case where the second cell replaces the first cell.

The cell related information may include a new physical cell identifier (PCI) that will apply in respect of the first cell when the first cell is provided by the access network node via a second non-terrestrial platform following a change of non-terrestrial platform, or that will apply in respect of a second cell provided by the access network node via the second non-terrestrial platform that replaces the first cell following the change of non-terrestrial platform.

The method may further comprise, (re) detecting the first cell, or in the second cell in a case where the second cell replaces the first cell, based on the new PCI before continuing communication.

The cell related information may include information indicating a time at which, and/or another condition that will be met when, the change of non-terrestrial platform will change.

The cell related information may include assistance information for the second non-terrestrial platform.

The method may further comprise acquiring assistance information for the second non-terrestrial platform broadcast via the second non-terrestrial platform before continuing communication.

The method may further comprise temporarily suspending uplink communication before continuing communication.

The method may further comprise recalculating a timing alignment for communication via the second non-terrestrial platform before continuing communication.

In another aspect there is provided a method performed by an access network node, the method comprising: communicating with a user equipment (UE), in a first cell provided by the access network node, via a first non-terrestrial platform, based on a connection configuration; transmitting, to the UE, via the first non-terrestrial platform, cell related information: that will apply in respect of the first cell when the first cell is provided by the access network node via a second non-terrestrial platform following a change of non-terrestrial platform; or that will apply in respect of a second cell provided by the access network node via the second non-terrestrial platform that replaces the first cell following the change of non-terrestrial platform; and continuing communication with the UE, based on the connection configuration, in the first cell, or in the second cell in a case where the second cell replaces the first cell.

In another aspect there is provided a candidate access network node comprising: means for receiving, from a serving access network node, at least one message for requesting preparation for a conditional handover, for a user equipment (UE), from a serving cell of the serving access network node, to at least one candidate cell of the candidate access network node, wherein the at least one candidate cell is a candidate to be a target cell for the conditional handover and the candidate access network node is a candidate to be a target access network node for the conditional handover; and means for transmitting, to the serving access network node, at least one message including configuration information for the conditional handover to the at least one candidate cell; wherein the configuration information includes information indicating that, in a case where the UE performs an access procedure to access the at least one candidate cell, the access procedure is to be performed without using a random access channel.

In another aspect there is provided a serving access network node comprising: means for transmitting, to at least one candidate access network node, at least one message for requesting preparation for a conditional handover, for a user equipment (UE), from a serving cell of the serving access network node, to at least one candidate cell of the candidate access network node, wherein the at least one candidate cell is a candidate to be a target cell for the conditional handover and the at least one candidate access network node is a candidate to be a target access network node for the conditional handover; means for receiving, from the target access network node, at least one message including configuration information for the conditional handover to the at least one candidate cell; and means for transmitting, to the UE, the configuration information for the conditional handover; wherein the configuration information includes information indicating that, in a case where the UE performs an access procedure to access the at least one candidate cell, the access procedure is to be performed without using a random access channel.

In another aspect there is provided a user equipment (UE) comprising: means for receiving, from a serving access network node, configuration information for a conditional handover from a serving cell of the serving access network node, to at least one candidate cell of at least one candidate access network node, wherein the at least one candidate cell is a candidate to be a target cell for the conditional handover and the at least one candidate access network node is a candidate to be a target access network node for the conditional handover; wherein the configuration information includes information indicating that, in a case where the UE performs an access procedure to access the at least one candidate cell, the access procedure is to be performed without using a random access channel.

In another aspect there is provided a user equipment (UE) comprising: means for transmitting, to an access network node as part of an initial access procedure that does not involve use of a random access channel, an initial uplink message using at least one uplink resource, wherein the at least one uplink resource is a resource configured for contention based uplink communication; means for, in a case where a contention resolution indication is not received from the access network node within a first time period, resending the initial uplink message to the access network node using the at least one uplink resource; means for, in a case where a contention resolution indication is received from the access network node within the first time period, treating the initial access procedure as successfully completed in further communication with the access network node; and means for, in a case where a contention resolution indication is not received from the access network node within a second time period, treating the initial access procedure as not having been successfully completed.

In another aspect there is provided an access network node comprising: means for receiving, from a user equipment (UE) as part of an initial access procedure that does not involve use of a random access channel, an initial uplink message using at least one uplink resource, wherein the at least one uplink resource is a resource configured for contention based uplink communication; means for transmitting a contention resolution indication to the UE; and means for treating the initial access procedure as successfully completed in further communication with the UE.

In another aspect there is provided a user equipment (UE) comprising: means for communicating with an access network node, in a first cell provided by the access network node, via a first non-terrestrial platform, based on a connection configuration; means for receiving from the access network node, via the first non-terrestrial platform, cell related information: that will apply in respect of the first cell when the first cell is provided by the access network node via a second non-terrestrial platform following a change of non-terrestrial platform; or that will apply in respect of a second cell provided by the access network node via the second non-terrestrial platform that replaces the first cell following the change of non-terrestrial platform; and means for following the change of non-terrestrial platform, preparing for communication via the second non-terrestrial platform based on the cell related information; and means for continuing communication with the access network node, based on the connection configuration, in the first cell, or in the second cell in a case where the second cell replaces the first cell.

In another aspect there is provided an access network node comprising: means for communicating with a user equipment (UE), in a first cell provided by the access network node, via a first non-terrestrial platform, based on a connection configuration; means for transmitting, to the UE, via the first non-terrestrial platform, cell related information: that will apply in respect of the first cell when the first cell is provided by the access network node via a second non-terrestrial platform following a change of non-terrestrial platform; or that will apply in respect of a second cell provided by the access network node via the second non-terrestrial platform that replaces the first cell following the change of non-terrestrial platform; and means for continuing communication with the UE, based on the connection configuration, in the first cell, or in the second cell in a case where the second cell replaces the first cell.

Although for efficiency of understanding for those of skill in the art, the disclosure will be described in detail in the context of a 3GPP system (5G networks including NTN), the principles of the disclosure can be applied to other systems as well. Although the present disclosure is motivated largely by NTN use cases, the example embodiments can be applied for other use cases involving handovers, and especially conditional handovers (CHOs).

Aspects of the disclosure are set out in the appended independent claims optional but beneficial features are set out in the appended dependent claims.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the disclosure independently of (or in combination with) any other disclosed and/or illustrated features where it is technically feasible to do so. In particular but without limitation the features of any of the claims dependent from a particular independent claim may be introduced into that independent claim in any combination or individually wherever doing so does not cause a technically incompatibility or result in something that does not make technical sense.

### BRIEF DESCRIPTION OF DRAWINGS

Example embodiments of the disclosure will now be described, by way of example, with reference to the accompanying drawings in which:

FIG. 1 is a simplified sequence diagram illustrating a handover procedure involving RACH-less initial access to a target cell;

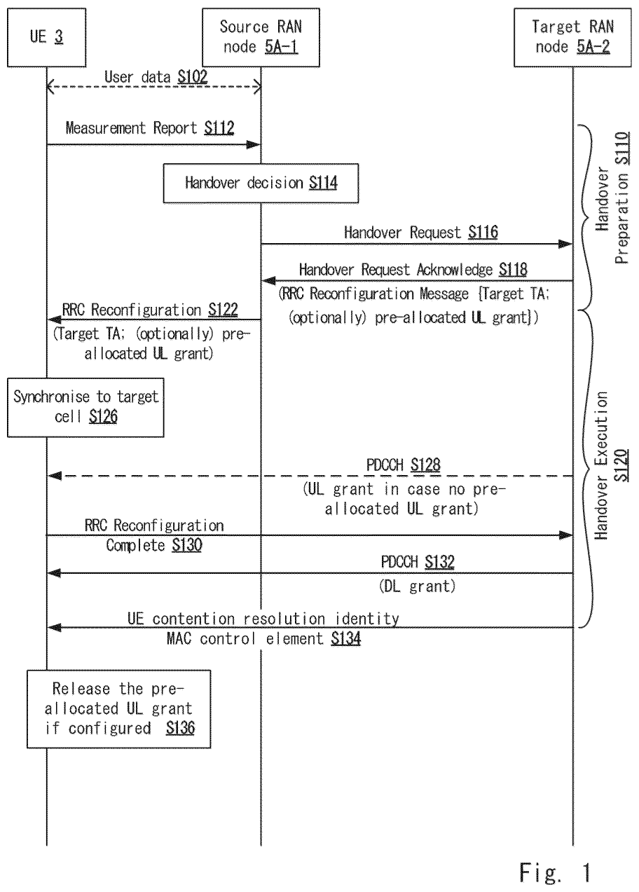

FIG. 2 illustrates schematically a mobile (cellular or wireless) communication system to which example embodiments of the disclosure may be applied;

FIG. 3 illustrates schematically a non-terrestrial network (NTN) radio access network that may be used in the communication system of FIG. 2;

FIG. 4 is a simplified illustration of part of an ASN.1 definition of a data structure for an NTN configuration information element that may be used in the communication system of FIG. 2;

FIG. 5A respectively illustrates a possible architecture of an NTN RAN;

FIG. 5B respectively illustrates a possible architecture of an NTN RAN;

FIG. 5C respectively illustrates a possible architecture of an NTN RAN;

FIG. 6 is a simplified sequence diagram illustrating a RACH-based conditional handover procedure that may be used in the communication system of FIG. 2;

FIG. 7 illustrates a typical service link switch/satellite switch scenario, in which there is a change in service link switch/satellite serving the area in which a UE is located;

FIG. 8 is a simplified sequence diagram illustrating a RACH-less conditional handover procedure that may be used in the communication system of FIG. 2;

FIG. 9 shows a simplified time-frequency diagram illustrating how an uplink grant may be configured for a contention based PUSCH in the communication system of FIG. 2;

FIG. 10 is a simplified sequence diagram illustrating a RACH-less initial access procedure, using a contention-based PUSCH, that may be used in the communication system of FIG. 2;

FIG. 11 is a simplified sequence diagram illustrating another RACH-less conditional handover procedure that may be used in the communication system of FIG. 2;

FIG. 12 is a simplified sequence diagram illustrating a procedure for reporting a predicted cell leaving/entry time, in the context of RACH-less conditional handover procedure, which may be used in the communication system of FIG. 2;

FIG. 13 is a simplified sequence diagram illustrating a procedure for configuring a validity time window, in the context of RACH-less conditional handover procedure, which may be used in the communication system of FIG. 2;

FIG. 14 is a simplified sequence diagram illustrating a first simplified RACH-less procedure, which may be used in the communication system of FIG. 2;

FIG. 15 is a simplified illustration of part of an ASN. 1 definition of a data structure for a system information block that may be used in the procedure of FIG. 14;

FIG. 16 is a simplified illustration of part of an ASN. 1 definition of a data structure for an RRC reconfiguration message that may be used in the procedure of FIG. 14;

FIG. 17 is a simplified sequence diagram illustrating a first simplified RACH-less procedure, which may be used in the communication system of FIG. 2;

FIG. 18 is a simplified block schematic illustrating the main components of a user equipment that may be used in the communications system of FIG. 2; and

FIG. 19 is a simplified block schematic illustrating the main components of a base station/access network node that may be used in the communications system of FIG. 2.

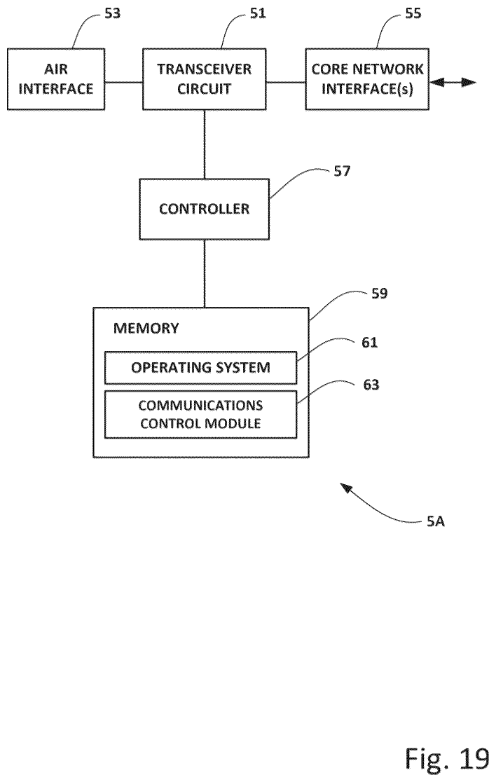

### DESCRIPTION OF EMBODIMENTS

### Overview

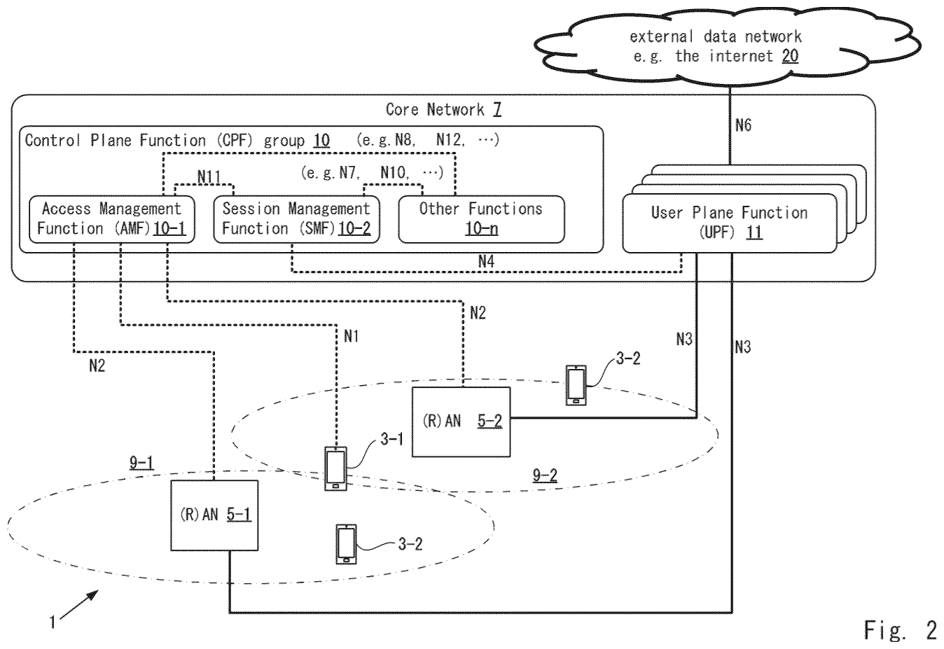

An exemplary communication system will now be described in general terms, by way of example only, with reference to FIGS. 2 to 6.

FIG. 2 schematically illustrates a mobile (‘cellular’ or ‘wireless’) communication system 1 to which example embodiments of the present disclosure are applicable.

In the network 1 user equipment (UEs) 3 (3-1, 3-2, 3-3) (e.g. mobile telephones and/or other mobile devices) can communicate with each other via a corresponding radio access network (RAN) 5-1, 5-2 that operates according to one or more compatible radio access technologies (RATs). In the illustrated example, each RAN 5-1, 5-2 includes a base station 5A (5A-1, 5A-2) (e.g., an NR/5G base station 5A (5A-1, 5A-2) such as a gNB 5A (5A-1, 5A-2)) that respectively operates one or more associated cells 9 (9-1, 9-2).

As those skilled in the art will appreciate, whilst three UEs 3, and two RANs 5-1, 5-2 are shown in FIG. 2 for illustration purposes, the system, when implemented, will typically include other RAN 5 and UEs 3.

Each RAN 5-1, 5-2 controls one or more associated cells either directly, or indirectly via one or more other nodes (such as home base stations, relays, remote radio heads, distributed units, and/or the like). It will be appreciated that the RAN 5 may be configured to support both 4G and 5G, and/or any other 3GPP or non-3GPP communication protocols.

The base station of each RAN 5 may be a distributed base station comprising at least one distributed unit (DU) 5A_{DU} (e.g., a gNB-DU or the like), and a central unit (CU) 5A_{CU} (e.g., a gNB-CU or the like). In such a distributed base station the CU employs a separated control plane and user plane and so is, itself, split between a control plane function (CU-CP) and a user plane function (CU-UP) which respectively communicate, with the DU via an F1-C logical interface and an F1-U logical interface (together forming an F1 interface (or ‘reference point’)), and with one another via an E1 logical interface. It will be appreciated that while the DU may include the physical and virtual elements required to provide the functionality of the lower parts of the PHY layer and hence communicate with the UEs 3 over the air interface, the base station may alternatively (or additionally) include one or more separate radio units (RUS) (e.g., providing this functionality of the lower parts of the PHY layer). It will, nevertheless, be appreciated that the base station may be in a non-distributed form, for example as an integrated gNB or eNB.

The UEs 3 and their serving RAN 5 are connected via an appropriate air interface (for example the so-called ‘Uu’ interface and/or the like). Base stations of neighbouring RANs 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the communication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) 10-2 and a number of other functions 10-n (such as, for example, an Authentication Server Function (AUSF) which facilitates 5G security processes, a Unified Data Management (UDM) entity for managing user specific data (e.g., for access authorization, user registration, and data network profiles), a Policy Control Function (PCF), an Application Function (AF), and/or the like). It will be appreciated that the nodes or functions may have different names in different systems.

The RAN 5 is connected to the core network nodes via appropriate interfaces (or ‘reference points’) such as an N2 reference point between the base station of the RAN 5 and the AMF 10-1 for the communication of control signalling, and an N3 reference point between the base station of the RAN 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the RAN 5.

One or more UPFs 11 are connected to an external data network (e.g. an IP network such as the internet) via reference point N6 for communication of the user data.

The AMF 10-1 performs mobility management related functions, maintains the NAS signalling connection with each UE 3 and manages UE registration. The AMF 10-1 is also responsible for managing paging.

The SMF 10-2 is connected to the AMF 10-1 via an N11 reference point. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3. The SMF 10-2 uses user information provided via the AMF 10-1 to determine what session manager would be best assigned to the user. The SMF 10-2 may be considered effectively to be a gateway from the user plane to the control plane of the network. The SMF 10-2 also allocates IP addresses to each UE 3.

The RAN 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block, MIB. It also, in conjunction with the PDCCH, supports the synchronisation of time and frequency, which aids cell acquisition, selection and re-selection.

The DL physical signals may include, for example, reference signals (RSs) and synchronization signals (SSs). A reference signal (sometimes known as a pilot signal) is a signal with a predefined special waveform known to both the UE 3 and the base station of the RAN 5. The reference signals may include, for example, cell specific reference signals, UE-specific reference signal (UE-RS), downlink demodulation signals (DMRS), and channel state information reference signal (CSI-RS).

Similarly, the UEs 3 are configured for transmission of, and the base station of the RAN 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, demodulation reference signals (DMRS) for a UL control/data signal, and/or sounding reference signals (SRS) used for UL channel measurement.

The UEs 3 and base station 5A of the RAN 5 of the communication system 1 are mutually configured for performing a random access channel (RACH) procedure for the UE 3 to access the network. Specifically, on detection and selection of a cell (and/or a beam in the case of 5G) the UE 3 is able to attempt access to that cell and/or beam using an initial radio resource control (RRC) connection setup procedure comprising a random access procedure. Prior to attempting initial access the UE 3 chooses random access resources (including, for example, a preamble) to use to initiate the RACH procedure. The UE 3 sends the selected preamble (e.g., in ‘Msg1’) to the base station of the RAN 5 over a physical random access channel (PRACH) for initiating the process to obtain synchronization in the uplink (UL). In response, the base station of the RAN 5 responds with a random access response (RAR) (or ‘Msg2’). The RAR indicates reception of the preamble and includes: a timing-alignment (TA) command for adjusting the transmission timing of the UE based on the timing of the received preamble; an uplink grant field indicating the resources to be used in the uplink for a physical uplink shared channel (PUSCH); a frequency hopping flag to indicate whether the UE is to transmit on the PUSCH with or without frequency; a modulation and coding scheme (MCS) field from which the UE can determine the MCS for the PUSCH transmission; and a transmit power control (TPC) command value for setting the power of the PUSCH transmission. The UE 3 then sends a third message (‘Msg3’) to the network over a physical uplink shared channel (PUSCH) based on the information in the RAR. The specific message sent by the UE in this step, and the content of the message, depends on the context in which the random access procedure is being used. In the example of initial radio RRC connection setup, however, Msg3 typically comprises an RRC Setup request or similar message carrying a temporary randomly generated UE identifier. The network responds with a fourth message (‘Msg4’) which carries the randomly generated UE identifier received in Msg3 for contention purposes to resolve any collisions between different UEs using the same preamble sequence. When successful, Msg4 also transfers the UE to a connected state.

While a four-step contention-based RACH procedure is described it will be appreciated that a UE 3 and the base station of the RAN 5 of the communication system 1 may also perform a non-contention based (or ‘contention free’) procedure in which a dedicated preamble is assigned by the base station of the RAN 5 to the UE. Moreover, a UE 3 and the base station of the RAN 5 of the communication system 1 may perform a two-step RACH procedure (e.g., as described in the introduction).

It will be appreciated that while the UE 3 can trigger initiation of the RACH procedure itself (e.g., when the UE 3 needs to connect to the network), initiation of the RACH procedure may be by the network. For example, a RACH procedure may be initiated via a message sent via downlink control information (DCI) with an appropriate DCI format (e.g. 1_0) in a physical downlink control channel (PDCCH)—such a message id commonly known as a PDCCH order. A RACH procedure may be also initiated by the base station of the RAN 5 when handover is required (e.g., using a handover command message).

### NTN RAN

In the exemplary communication system 1, each RAN 5 may be implemented as a non-terrestrial network (NTN) RAN 5.

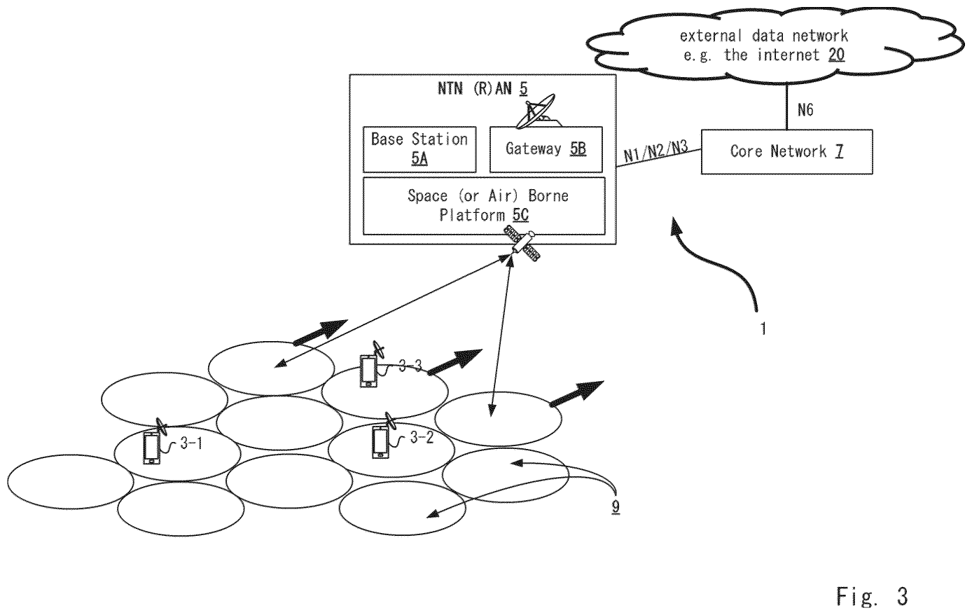

FIG. 3 illustrates schematically one such NTN RAN 5 that may be used in the communication system of FIG. 2.

As seen in FIG. 3, the NTN RAN 5 comprises a base station or 5A operating one or more associated cells 9, a gateway 5B, and a non-terrestrial (space or air borne) platform 5C (e.g. comprising one or more satellites and/or airborne vehicles), which may be referred to generally as a ‘satellite’ 5C for simplicity. Communication via the NTN RAN 5 is routed through the core network 7 and external data network 20 (e.g. via the N6 interface/reference point).

The NTN RAN 5 controls a number of directional satellite beams via which associated NTN cells 9 may be provided. Specifically, each satellite beam has an associated footprint on the surface of the Earth which forms an NTN cell, or part of an NTN cell. Each NTN cell has an associated Physical Cell Identity (PCI). The satellite beam footprints may be moving as the satellite 5C is travelling along its orbit (e.g. as illustrated by the arrows A in FIG. 3). Alternatively, the satellite beam footprint may be earth fixed, in which case an appropriate satellite beam pointing mechanism (mechanical or electronic steering) may be used to compensate for the movement of the satellite 5C. Satellite beams and satellites are not considered visible from a UE perspective in NTN. This does not, however, preclude differentiating at the public land mobile network (PLMN) level the type of network (e.g. NTN vs. terrestrial).

The base station 5A of the NTN RAN 5 is configured to provide ephemeris data for the satellite 5C, to the UEs 3, to help UEs 3 perform measurement and cell selection/reselection and for supporting initial access. This ephemeris data may comprise information on orbital information such as information on orbital plane level or on satellite level and/or information (e.g. a pointer or index) from which more detailed ephemeris data stored in the UE 3 (e.g. in a subscriber identity module, ‘SIM’) may be obtained. At least some of this ephemeris information may, for example, be provided in system information and/or may be provided using UE specific (dedicated) signalling such as RRC signalling.

Specifically, the base station 5A is able to provide satellite assistance information for the satellite as part of a dedicated system information block (SIB) that is broadcast to UEs 3 in a corresponding cell 9 of the NTN RAN 5 (for 5G NTN this may, for example, be SIB19 but for future generations it may be provided in another SIB or in a different way). The satellite assistance information may include, for example, information identifying at least one associated NTN configuration (e.g., as part of an NTN-Config IE or the like). The NTN configuration includes parameters for assisting the UE 3 to access the network using NTN access (e.g., ephemeris data, common timing alignment parameters, a scheduling (e.g., k_offset), validity duration for uplink synchronisation information, and an epoch time (a reference time for which assistance information is valid)).

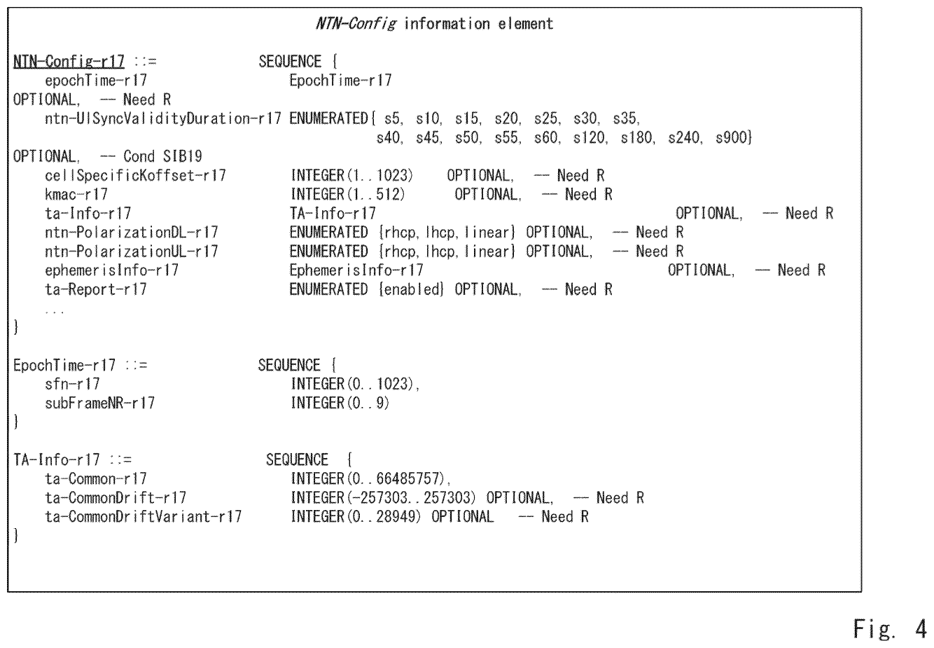

FIG. 4 shows, by way of example only, an abstract syntax notation one (ASN. 1) definition of a data structure for an NTN configuration information element that may be used in the communication system of FIG. 2.

The satellite assistance information may include, for example, an indication of a time information on when a cell provided via NTN quasi-Earth fixed system is going to stop serving the area it is currently covering (e.g., in a t-Service IE). This may be indicated, for example, as a time in multiples of 10 ms after 00:00:00 on a Gregorian calendar date of 1 Jan. 1900 (midnight between Sunday, Dec. 31, 1899, and Monday, Jan. 1, 1900). The exact stop time may be between the time indicated by the value of this field minus 1 and the time indicated by the value of this field.

With the help of this ephemeris data, a UE 3 may search for the first NTN cell it can connect to. After detecting a synchronization signal block (SSB) of a cell 9 broadcasted via a satellite 5C, the UE 3 may be able to read initial system information of that cell which may contain further ephemeris information relating to the exact location of the cell (and/or to the satellite broadcasting the cell). This ephemeris information may be given relative to information relating, for example, to the orbital plane that the UE 3 may already have obtained.

The accuracy of the prediction of a satellite orbit or the satellite position can decrease with time and so, to help ensure accuracy, the ephemeris data provided to the UE 3 is updated (a) periodically.

The same PCI may be used for several satellite beams, or there may be one PCI per satellite beam. A satellite beam can consist of one or more SSB beams with one cell (PCI) having a maximum of L SSB beams, where L can typically be 4, 8 or 64 depending on the band. During initial access, the UEs 3 perform cell search based on SSBs where each SSB is transmitted in a different respective beam. Each SSB comprises a primary synchronization signal (PSS), secondary synchronization signal (SSS), and physical broadcast channel (PBCH). As the SSB carries synchronization signals (SSs)/PBCH (SS/PBCH) transmissions it is sometimes referred to as an SS/PBCH block.

As those skilled in the art will understand, while the disclosure is described in the context of an NTN based RAN/base station, many of the technical features described are generally applicable to, and can be implemented in, any RAN/base station of a more conventional (non-NTN) based communication system.

### NTN RAN Architecture

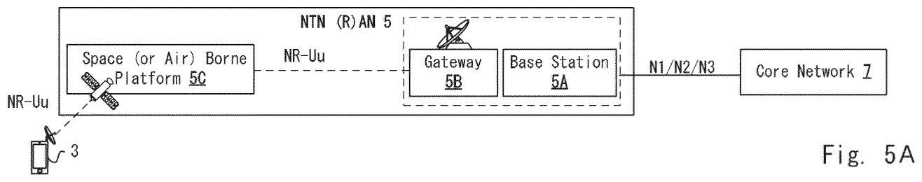

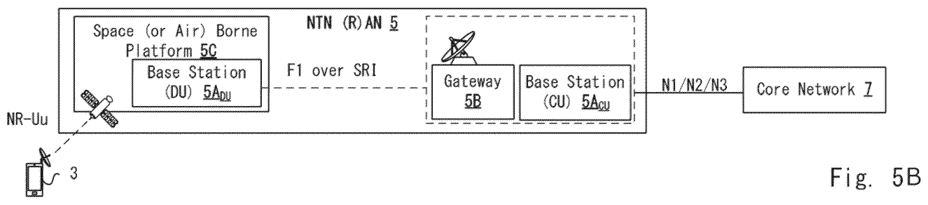

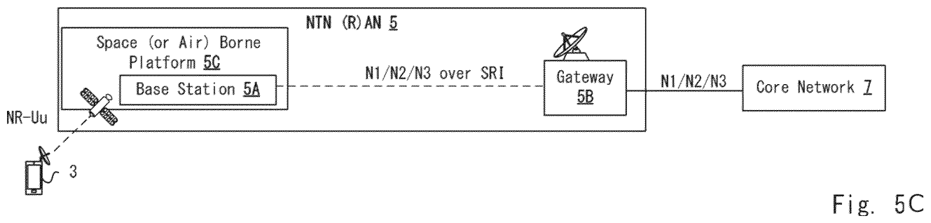

FIGS. 5A to 5C each respectively illustrate a possible architecture of an NTN RAN 5 that may be used.

For the purposes of description, when implemented in the communication system 1, the NTN RAN 5 will be described in terms of the architecture illustrated in FIG. 5A. It will be appreciated, however, that the NTN RAN 5 could potentially use a different one of the architectures and the entities of the communication system 1 could be adapted accordingly.

The architecture of FIG. 5A may be referred to as a ‘transparent satellite’ based RAN architecture. In this architecture, the base station 5A is a terrestrially located base station that sends and receives communications respectively destined for and originating from the UEs 3 via a terrestrially located gateway 5B and via a satellite 5C that has no base station functionality. The satellite 5C relays these communications to and from the UEs 3 in one or more cells operated by the base station 5A, and from and to the gateway 5B as required. The non-terrestrial platform 5C relays these communications transparently without on-board processing them in effect acting as a so-called ‘bent-pipe’. In this implementation, the feeder link between the gateway 5B and the satellite 5C effectively acts as part of the NR-Uu interface (or reference point) between the base station 5A and one or more UEs 3. Similarly, the service link between the satellite 5C and one or more UEs 3 effectively acts as another part of the NR-Uu interface (or reference point) between the base station 5A and one or more UEs 3. The base station's communication link with the core network 7 (e.g. for signalling over the N1, N2, N3 interface/reference point etc.) is provided solely terrestrially.

The architecture of FIG. 5B may be referred to as a ‘regenerative satellite’ based RAN architecture (i.e., in which the satellite performs on board processing of the payload being communicated between the UE 3 and the core network 7). In this architecture, the base station 5A is a base station 5A of a distributed type having a terrestrially located central unit (CU) 5A_{CU} and a distributed unit (DU) 5A_{DU} provided on-board the satellite 5C. The terrestrially located CU 5A_{CU} performs some of the (typically higher layer) functionality of the base station 5A whereas the non-terrestrially located DU 5A_{DU} performs other (typically lower layer) functionality of the base station 5A. The terrestrially located CU 5A_{CU} communicates with the non-terrestrially located DU 5A_{DU} via the gateway 5B and an F1 interface implemented via a satellite radio interface between the gateway 5B and the satellite 5C in which the DU 5A_{DU} is provided.

The satellite 5C transmits communications destined for and originating from the UEs 3 in one or more cells operated by the base station 5A, and from and to the gateway 5B as required. However, in this implementation lower layer processing of communication respectively destined for and originating from one or more UEs 3 is performed on-board the satellite 5C by the DU 5A_{DU} and higher layer processing of that communication respectively destined for and originating from the UEs 3 is performed by the terrestrially located CU 5A_{CU}.

Accordingly, in this implementation, the feeder link between the gateway 5B and the satellite 5C effectively acts as the F1 interface (or reference point) between the CU 5A_{CU} and DU 5A_{DU} of the base station 5A. The service link between the satellite 5C and one or more UEs 3, on the other hand, effectively acts as the NR-Uu interface (or reference point) between the base station 5A and one or more UEs 3. The base station's communication link with the core network 7 (e.g. for signalling over the N1, N2, N3 interface/reference point etc.) is provided solely terrestrially.

The architecture of FIG. 5C may also be referred to as a ‘regenerative satellite’ based RAN architecture (i.e., in which the satellite performs on board processing of the payload being communicated between the UE 3 and the core network 7). In this architecture, the base station 5A is provided on-board the satellite 5C. The base station 5A on board the satellite 5C transmits communications destined for and originating from the UEs 3 in one or more cells operated by the base station 5A, and from and to the core network 7 via the gateway 5B as required. However, in this implementation, processing of communication respectively destined for and originating from the UEs 3 is performed on-board the satellite 5C by the base station 5A.

Accordingly, in this implementation, the feeder link between the gateway 5B and the satellite 5C effectively acts as part of the N1/N2/N3 interfaces (or reference points) between the base station 5A and the core network 7. The base station's communication link with the core network 7 (e.g. for signalling over the N1, N2, N3 interface/reference point etc.) is thus provided partly via the feeder link and partly terrestrially. The service link between the satellite 5C and one or more UEs 3, on the other hand, effectively acts as the NR-Uu interface (or reference point) between the base station 5A and one or more UEs 3.

The base station 5A thus controls one or more associated cells via the n satellite 5C. It will be appreciated that the base station 5A may be configured to support both 4G and 5G, and/or any other 3GPP or non-3GPP communication protocols.

### RACH-Based Conditional Handover

The UEs 3 and RAN 5 of the communication system 1 are mutually configured for performing RACH-based conditional handover (CHO) when necessary.

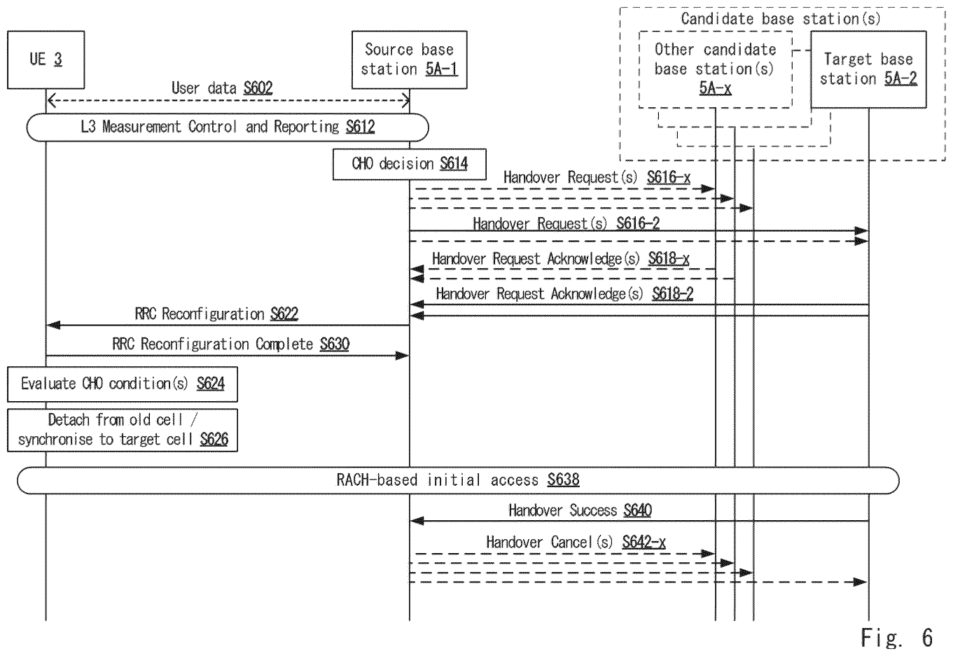

An exemplary RACH-based conditional handover (CHO) procedure that may be used in the communication system 1, will now be described, by way of example only, with reference to FIG. 6.

FIG. 6 is a simplified sequence diagram illustrating the RACH-based conditional handover procedure that may be implemented in the communication system 1.

Referring to FIG. 6, the CHO procedure in this case concerns a handover of a UE 3 between a source cell of a source base station 5A-1 and a target cell (of potentially plural candidate cells) of a target base station 5A-2. The target base station 5A may be one of a number of candidate base stations (i.e., candidates with the potential to become the target base station 5A-2 for the handover) each of which may operate one or more candidate cells (i.e., candidates with the potential to be the target cell).

Before the CHO procedure starts, the source base station 5A-1 serving and communicating with the UE 3 at S602 (i.e., the source base station 5A-1 of the CHO), will typically have a UE context for the UE 3 stored. This may include, for example, information regarding roaming and access restrictions which were provided either at establishment of the connection between the UE and the source base station 5A-1 or at the last tracking area update.

The source base station 5A-1 configures measurement procedures to be performed by the UE 3, and the UE 3 reports according to the measurement configuration (at S612). At some point, the source base station 5A-1 makes a decision to configure the UE 3 for a CHO to handover the UE 3 (at S614), for example based on measurement results received in a measurement report and/or radio resource management (RRM) information.

The source base station 5A-1 therefore proceeds, at S616-x and/or S616-2, to send a respective handover request, to request CHO, for each of one or more candidate cells belonging to one or more of the candidate base stations 5A-x, 5A-2 including the target base station 5A-2. A CHO request message is sent for each candidate cell.

While not shown, it will be appreciated that, admission control may be performed by each candidate base station 5A-x, 5A-2. Slice-aware admission control may, for example, be performed if corresponding slice information is sent to that candidate base station 5A-x, 5A-2 and if protocol data unit (PDU) sessions are associated with non-supported slices that candidate base station 5A-x, 5A-2 may reject such a PDU session.

Each candidate base station 5A-x, 5A-2 sends, to the source base station 5A-1, a respective CHO response (e.g., a handover request acknowledge message or the like) for each CHO candidate cell (at S618-x, S618-2). Each CHO response includes a configuration for the corresponding CHO candidate cell (e.g., in an RRC reconfiguration message or the like).

The source base station 5A-1 sends an RRC reconfiguration message (e.g., an RRCReconfiguration message in 5G systems) to the UE 3 at S622. The RRC reconfiguration message includes information indicating the configuration for each CHO candidate cell and information indicating one or more CHO execution conditions determined by the source base station 5A-1. It will be appreciated that, although not illustrated, the CHO configuration of one or more candidate cells may be followed by other reconfiguration information from the source base station 5A-1.

The UE 3 sends an appropriate RRC reconfiguration complete message (e.g., an RRCReconfigurationCompletion message in 5G systems) to the source base station 5A-1 at S630 (effectively confirming the RRC reconfiguration).

The UE 3 maintains the connection with the source base station 5A-1 after receiving CHO configuration and starts evaluating the CHO execution conditions for one or more candidate cells (e.g., based on measurements performed by the UE 3) at S624. If one or more measurement results for at least one CHO candidate cell satisfies the corresponding CHO execution condition, the UE 3 detaches from the source base station 5A-1, applies the stored corresponding configuration for that selected candidate cell (which is the target cell of handover), and synchronises to that candidate (target) cell (at S626).

The UE 3 the performs a RACH-based initial access procedure with the candidate (i.e., target) base station 5A-2 that operates the target cell, at S638. Specifically, the UE 3 sends a selected preamble (e.g., in ‘Msg1’) to the target base station 5A-2 over the RACH for initiating the process to obtain synchronisation in the uplink (UL). In response, the base station of the RAN 5 responds with a RAR (or ‘Msg2’). The RAR indicates reception of the preamble and includes a timing-alignment (TA) command for adjusting the transmission timing of the UE 3 based on the timing of the received preamble, and an uplink grant field indicating the resources to be used in the PUSCH (along with other information as appropriate). The UE 3 then sends an RRC reconfiguration complete message (e.g., an RRCReconfigurationCompletion message in 5G systems) as Msg3 to the network over the PUSCH based on the information in the RAR. This completes the RRC handover procedure. The UE releases stored CHO configurations after successful completion of RRC handover procedure.

The target base station 5A-2 will then send, S640 a message indicating handover has been successful (e.g. a Handover Success message) to the source base station 5A-1 to inform the source base station 5A-1 that the UE 3 has successfully accessed the target cell. The source base station 5A-1 can then, if necessary, send (at S642-x) a message to cancel handover (e.g. a Handover Cancel message) for any other candidate cells of the target base station 5A-2, and/or of any other candidate base station 5A-x, to cancel the CHO for the UE 3 at that candidate base station 5A-x.

### RACH-Less Conditional Handover

Beneficially, the UEs 3 and RAN 5 of the communication system 1 are also mutually configured for performing RACH-less conditional handover (CHO) when necessary.

Specifically, as described in more detail later, for example, UEs 3 and RAN 5 of the communication system 1 may be mutually configured for performing a general RACH-less CHO procedure. In this procedure, RACH-skip/RACH-less can be configured by one or more candidate base stations 5A-x/5A-2 for one or more associated candidate cells (e.g., as an optional configuration of a corresponding CHO configuration). When RACH-skip is configured by a candidate base station 5A-x/5A-2 that candidate base station 5A-x/5A-2 can also further configure one or more associated pre-allocated periodical uplink grants (e.g., as an optional configuration of a corresponding CHO configuration). When a UE 3 detaches from the old (source) cell, the UE 3 can perform downlink and uplink synchronization to the new (target) cell without using a RACH procedure. As described in more detail later, the UE 3 can send an initial RRC Reconfiguration complete message using a PUSCH configured in accordance with any of a number of different options including: using a pre-configured CG (which could be subject to a ‘validity’ time window similar to that described later); using dynamic scheduling; and/or using a contention-based CG (as described in more detail later).

The UEs 3 and RAN 5 of the communication system 1 are also mutually configured for a number of enhancements and variations to the CHO procedure that may be used depending on requirements.

For example, the UEs 3 and RAN 5 of the communication system 1 are mutually configured for performing RACH-less initial access using a contention based PUSCH. The RACH-less initial access procedure using a contention based PUSCH may be used by UEs 3 either for initial access in a target cell after a CHO or, potentially, for initial access procedure during other mobility/cell change procedures including conventional handover (HO) and/or L1/L2 triggered mobility (LTM). Beneficially, the contention-based PUSCH also has the potential to provide benefits during an access procedure to form an initial connection in a cell (e.g., RRC connection setup) and/or to resume such a connection (e.g., RRC connection resume). In this example, the target base station 5-2A may be able to configure a contention-based PUSCH to the UE 3 via broadcast system information and/or via dedicated signalling. The contention-based PUSCH may, for example, be a periodical CG (i.e., that appears sequentially in time). Moreover, beneficially, multiple grants could, potentially, be configured in the same time slot but at a different frequency location. Multiple grants could also, potentially, be configured in a single contention-based PUSCH period (e.g., with different timings).

In another example, the UEs 3 and RAN 5 of the communication system 1 are mutually configured for performing a RACH-less CHO procedure in which, when one or more CHO execution conditions are fulfilled (or are going to fulfilled), the UEs report to the source (serving) base station 5A-1, in the source cell (current serving cell), that the UE 3 is about to execute CHO to a selected target cell. The source base station 5A-1 then informs the target base station 5A-2, in the target cell, of the upcoming CHO of the UE 3 to the target cell (e.g., for inter-base station CHO). This is particularly beneficial for the target base station 5A-2 to know when to start dynamic scheduling for the UE 3 in the target cell (i.e., at a (near) optimum time) and/or to know when a pre-configured/pre-allocated configured grant will actually be used in real time. In effect, therefore, by notifying the source base station 5A-1 of the impending CHO, the UE 3 provides an implicit indication of the approximate timing of the CHO that can be used by the target base station 5A-2 to optimise the timing of downlink scheduling and/or the timing of PUSCH monitoring/receptions.

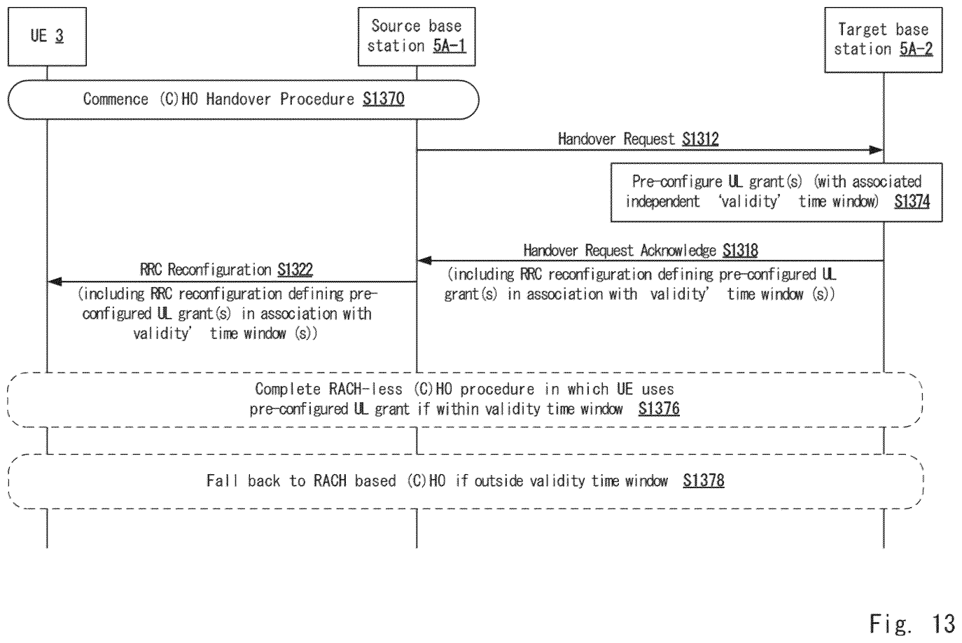

In another example, the UEs 3 and RAN 5 of the communication system 1 are mutually configured for performing a RACH-less CHO procedure in which the UEs 3 are able to calculate a predicted time of leaving a current cell (i.e., serving/source cell) and/or or a predicted time of entering another cell (i.e., neighbouring/target cell), and to report one or more predictions to the source (serving) base station 5A-1. The source base station 5A-1 then forwards the reported information to the target base station 5A-2, in the target cell. This prediction related information may then be used by the base station appropriately—for example: to pre-configure uplink grants appropriately (potentially with one or more associated ‘validity’ time windows, e.g., similar to that described below with reference to FIG. 13); and/or to decide a (near) optimum timing to start dynamic scheduling for the UE 3.

In another example, the RAN 5 of the communication system 1 is configured for configuring a ‘validity’ time window in association with a relevant CHO (or possibly conventional handover) configuration (e.g. in an RRC Reconfiguration message sent from a candidate/target base station 5A-x 5A-2 to the source base station 5A-1). This could, for example, be an independent time window or (in the case of CHO) may be linked to a time window defined by a configuration of a time-based CHO trigger event (e.g., the so-called ‘CondEvent T1’) in the case where the execution condition corresponds to that CHO trigger event. When the UE 3 has received a pre-configured uplink grant with the validity time window, the uplink grant would be considered valid during the indicated window. Otherwise that uplink grant would be suspended or released. If the CHO execution condition fulfilled, but the timing of fulfilment is out of the validity time window, then the UE 3 may be required to fall back to a RACH-based CHO procedure, use a configured uplink resource for a scheduling request (SR), or release the corresponding CHO configuration. The validity time may be applicable in a number of scenarios. For example, a validity time window may be used for a quasi-earth fixed cell case, where a time parameter is normally configured that indicates the time when a cell provided via an NTN quasi-Earth fixed system is going to stop serving the area it is currently covering (e.g., the parameter referred to as ‘t-Service’ described earlier), and hence the handover time is pre-determined. A validity time window may also be used for an earth-moving cell, in which it is predictable roughly how much time the UE 3 will stay in the current cell before handover happens, and/or the validity time may be determined based observed handover frequency. A network may also be able to base a validity time window based on a network-side prediction of the timing of a next handover of a UE 3, for example using an appropriate artificial intelligence/machine learning (AI/ML) algorithm.

It will be appreciated that the above exemplary features are not mutually exclusive. Nevertheless, the above exemplary features are also not mutually reliant on one another. Accordingly, any combination of one, some, or all the features could be implemented in the communication system 1 to provide an associated benefit.

### Satellite Switch

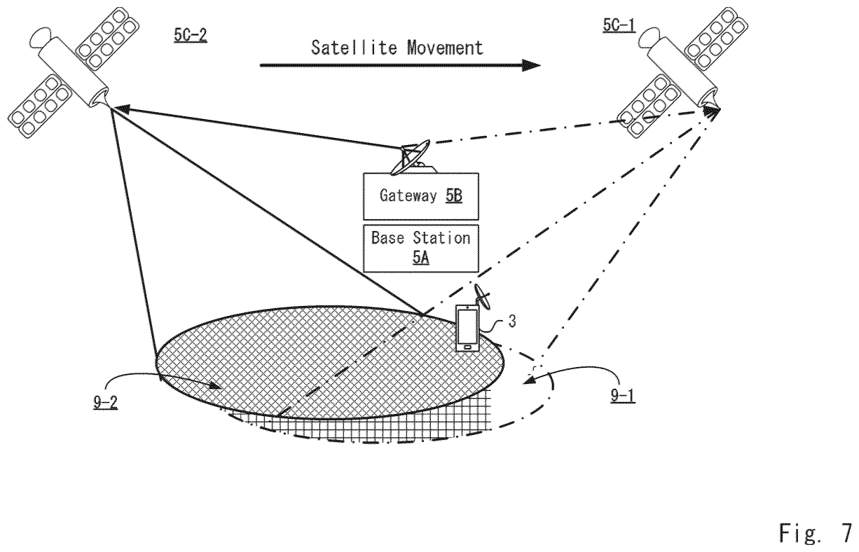

FIG. 7 illustrates a typical service link switch/satellite switch scenario, in which there is a change in service link/satellite serving the area in which a UE 3 is located from a first satellite (5C-1 to a second satellite 5C-2).

As seen in FIG. 7 when there is a change of service link/satellite arising from satellite movement in which the feeder link of the new satellite 5C-2 providing the new service link is via the same base station 5A and gateway 5B as the old satellite 5C-1, the physical RAN hardware (i.e., implementing the base station) via which the cell 9-1 when provided via the first satellite 5C-1, and the cell 9-2 when provided via the second satellite 5C-2, and the associated radio resources, remain unchanged. Hence, other than being provided via different satellites 5C-1, 5C-2 the cell 9-1 when provided via the first satellite 5C-1 and the cell 9-2 when provided via the second satellite 5C-2 are essentially the same serving cell 9.

Nevertheless, as explained above it is possible that the serving cell 9 will have different PCIs before and after satellite switch, although it is also possible that the serving cell 9 could have the same PCI before and after satellite switch.

Beneficially, as described in more detail, the UEs 3 and RAN 5 of the communication system 1 are also mutually configured for performing a simplified RACH-less procedure (i.e., without performing all the steps normally considered necessary for a (layer 3 (L3) handover procedure) in the event of a satellite switch occurring.

Advantageously, the UEs 3 and RAN 5 of the communication system 1 may be configured for a first version of the simplified RACH-less procedure for a scenario in which the PCI changes. Advantageously, the UEs 3 and RAN 5 of the communication system 1 may also be configured for a second version of the simplified RACH-less procedure for a scenario in which the PCI does not change.

Specifically, as described in more detail later, in the first version of the simplified RACH-less procedure at an indicated time (e.g., indicated by the t-Service parameter or some other parameter), or some other ‘replacement’ condition is met, indicating that the serving cell's PCI and satellite 5C-1 are being replaced with another satellite 5C-2 and PCI, the UE 3 executes neither a RACH procedure nor an L3 handover. The UE 3 simply detaches from the ‘old’ cell 9-1 (identified by the old PCI) and synchronises to the ‘new’/‘replacement cell’ (identified by a new PCI).

Further, as described in more detail later, in the second version of the simplified RACH-less procedure, when the serving cell's satellite 5C-1 is replaced with another satellite 5C-2, the UE 3 also executes neither a RACH procedure nor an L3 handover. The UE 3 simply (re) acquires appropriate satellite assistance information for the new satellite 5C-2 thereby allowing the UE 3 recalculate the timing alignment based on replacement satellite (and other necessary) information indicated by a newly (re) acquired NTN configuration corresponding to the new satellite 5C-2. Hence, the UE 3 may obtain an appropriate uplink synchronisation.

### RACH-Less Conditional Handover (General Procedure)

As mentioned above, the UEs 3 and RAN 5 of the communication system 1 may be mutually configured for performing a general RACH-less CHO procedure.

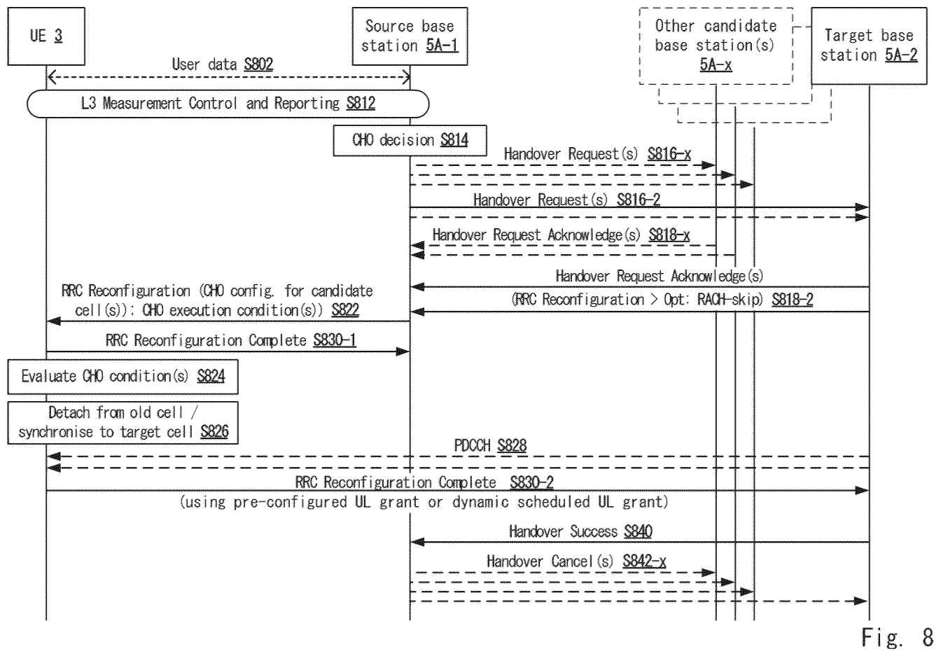

A possible such procedure will now be described, by way of example only, with reference to FIG. 8, which is a simplified sequence diagram illustrating a general RACH-less conditional handover procedure that may be used in the communication system 1.

Referring to FIG. 8, the CHO procedure in this case concerns a handover of a UE 3 between a source cell of a source base station 5A-1 and a target cell (of potentially plural candidate cells) of a target base station 5A-2. The target base station 5A-2 may be one of a number of candidate base stations (i.e., candidates with the potential to become the target base station 5A-2 for the handover) each of which may operate one or more candidate cells (i.e., candidates with the potential to be the target cell).

Before the CHO procedure starts, the source base station 5A-1 serving and communicating with the UE 3 at S802 (i.e., the source base station 5A-1 of the CHO), will typically have a UE context for the UE 3 stored. This may include, for example, information regarding roaming and access restrictions which were provided either at establishment of the connection between the UE and the source base station 5A-1 or at the last tracking area update.

The source base station 5A-1 configures measurement procedures to be performed by the UE 3, and the UE 3 reports according to the measurement configuration (at S812). At some point, the source base station 5A-1 makes a decision to configure the UE 3 for a CHO to handover the UE 3 (at S814), for example based on measurement results received in a measurement report and/or radio resource management (RRM) information.

The source base station 5A-1 therefore proceeds, at S816-x and/or S816-2, to send a respective handover request, to request CHO, for each of one or more candidate cells belonging to one or more of the candidate base stations 5A-x, 5A-2 including the target base station 5A-2. A CHO request message is sent for each candidate cell.

While not shown, it will be appreciated that, admission control may be performed by each candidate base station 5A-x, 5A-2. Slice-aware admission control may, for example, be performed if corresponding slice information is sent to that candidate base station 5A-x, 5A-2 and if protocol data unit (PDU) sessions are associated with non-supported slices that candidate base station 5A-x, 5A-2 may reject such a PDU session.

Each candidate base station 5A-x, 5A-2 sends, to the source base station 5A-1, a respective CHO response (e.g., a handover request acknowledge message or the like) for each CHO candidate cell (at S818-x, S818-2). Each CHO response includes a configuration for the corresponding CHO candidate cell (e.g., in an RRC reconfiguration message or the like). Each candidate base station 5A-x, 5A-2 is able to configure, as part of the corresponding CHO configuration, RACH-skip/RACH-less based CHO for a corresponding candidate cell. The RRC reconfiguration message carrying the CHO configuration for a candidate cell may, for example, a RACH-skip information element (IE) to indicate that RACH should be skipped for any access to that candidate cell should it become the target cell for CHO. A candidate base station 5A-x, 5A-2 that provides a CHO configuration for a candidate cell in which RACH-skip/RACH-less initial access has been configured may also (optionally) configure one or more pre-allocated periodical uplink grants (preconfigured CGs) that the UE 3 can use for the PUSCH carrying the first uplink message (e.g., RRC reconfiguration complete) in that candidate cell in the event that candidate cell becomes the target cell of the CHO procedure.

The source base station 5A-1 sends an RRC reconfiguration message (e.g., an RRCReconfiguration message in 5G systems) to the UE 3 at S822. The RRC reconfiguration message includes information indicating the configuration for each CHO candidate cell-including (where applicable) that RACH-skip is configured and any one or more pre-allocated periodical uplink grants- and information indicating one or more CHO execution conditions. It will be appreciated that, although not illustrated, the CHO configuration of one or more candidate cells may be followed by other reconfiguration information from the source base station 5A-1.

The UE 3 sends an appropriate RRC reconfiguration complete message (e.g., an RRCReconfigurationCompletion message in 5G systems) to the source base station 5A-1 at S830-1 (effectively confirming the RRC reconfiguration).

The UE 3 maintains the connection with the source base station 5A-1 after receiving CHO configuration and starts evaluating the CHO execution conditions for one or more candidate cells (e.g., based on measurements performed by the UE 3) at S824. If one or more measurement results for at least one CHO candidate cell satisfies the corresponding CHO execution condition, the UE 3 detaches from the source base station 5A-1, applies the stored corresponding configuration for that selected candidate cell (which is the target cell of handover), and synchronises to that candidate (target) cell (at S826).

If the target base station 5A-2 knows (or is able to calculate) a (predicted) timing at which one or more CHO conditions will be fulfilled, the target base station 5A-2 may, start to dynamically schedule a first/initial uplink grant to the UE 3 that is moving to the target cell (e.g., via a PDCCH carrying appropriate downlink control information (DCI)) at S828 based on the timing.

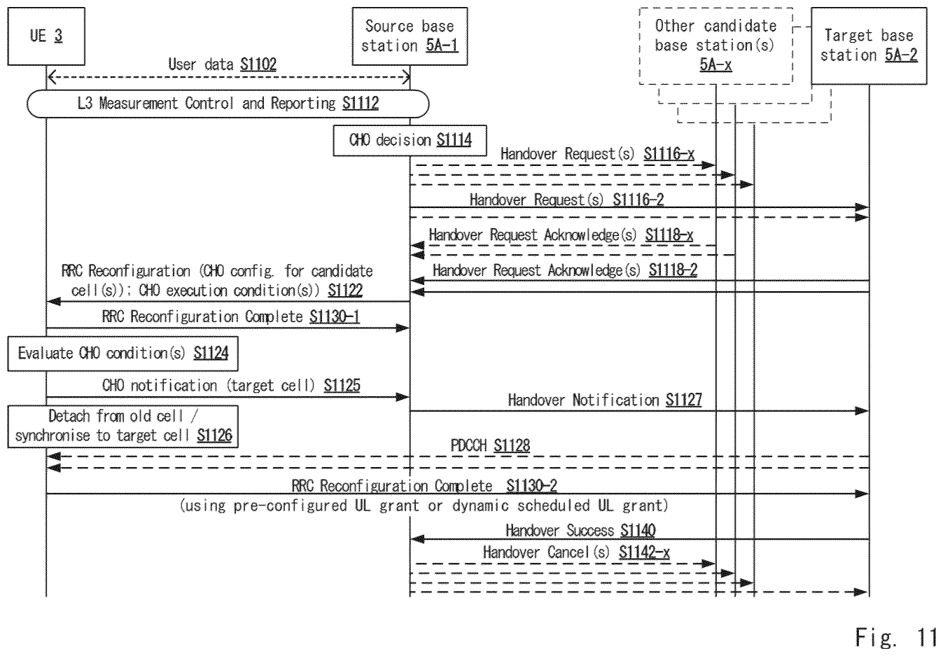

The timing may, for example, be known in a case where the service link/satellite changes (e.g., as illustrated in FIG. 7), since the timing of the serving link change will be known by the target base station 5A-2, and so the CHO time and scheduling time can be determined as well. Alternatively, the timing may be based on a notification provided by the UE 3, to the source base station 5A-1, that the UE 3 is about to execute CHO to the target cell and subsequently notified by the source base station 5A-1 to the target base station 5A-2 (e.g., as mentioned above and as described in more detail below with reference to FIG. 11).

The timing may, for example, be known in a case where the service link/satellite changes (e.g., as illustrated in FIG. 7), since the timing of the serving link change will be known by the target base station 5A-2, and so the CHO time and scheduling time can be determined as well.

The timing may (alternatively or additionally) be based on a notification provided by the UE 3, to the source base station 5A-1, that the UE 3 is about to execute CHO to the target cell and subsequently notified by the source base station 5A-1 to the target base station 5A-2 (e.g., as mentioned above and as described in more detail below with reference to FIG. 11).

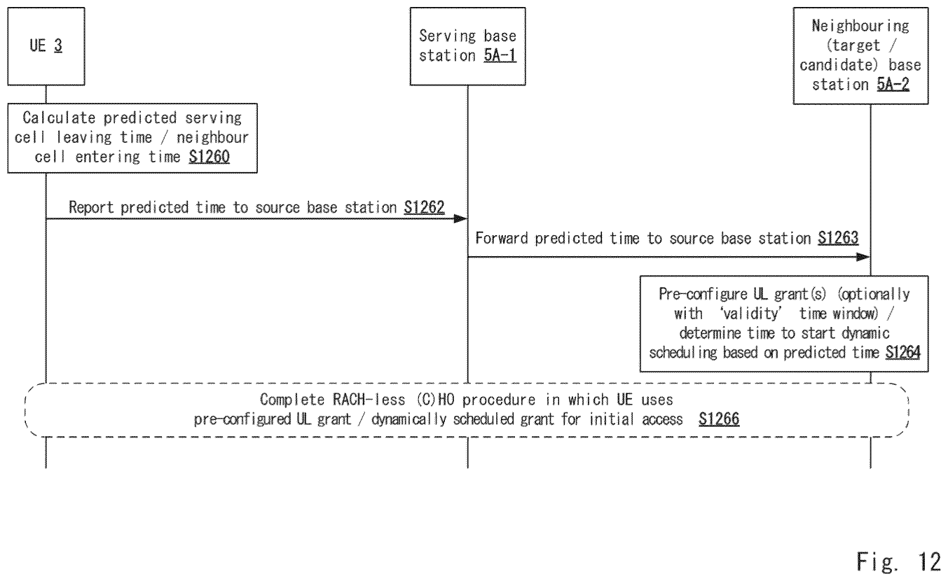

The timing may (alternatively or additionally) be based on a predicted time of leaving a current cell (i.e., serving/source cell) and/or or a predicted time of entering another cell (i.e., neighbouring/target cell), reported by the UE 3 to the source base station 5A-1 and forwarded by the source base station 5A-1 to the target base station 5A-2 (e.g., as mentioned above and as described in more detail below with reference to FIG. 12).

Where RACH-skip/RACH-less initial access has been configured for the candidate cell that becomes the target cell, the UE 3 may therefore engage in a RACH-less initial access procedure with the target base station 5A-2 in which it can send an RRC reconfiguration complete message (at S830-2) using a PUSCH with a pre-allocated/pre-configured uplink grant (CG) or a dynamically scheduled uplink grant (DG).

Where a PUSCH with a pre-allocated/pre-configured uplink grant (CG) is used a validity time may be (pre) configured (e.g., as mentioned above and as described in more detail below with reference to FIG. 13).

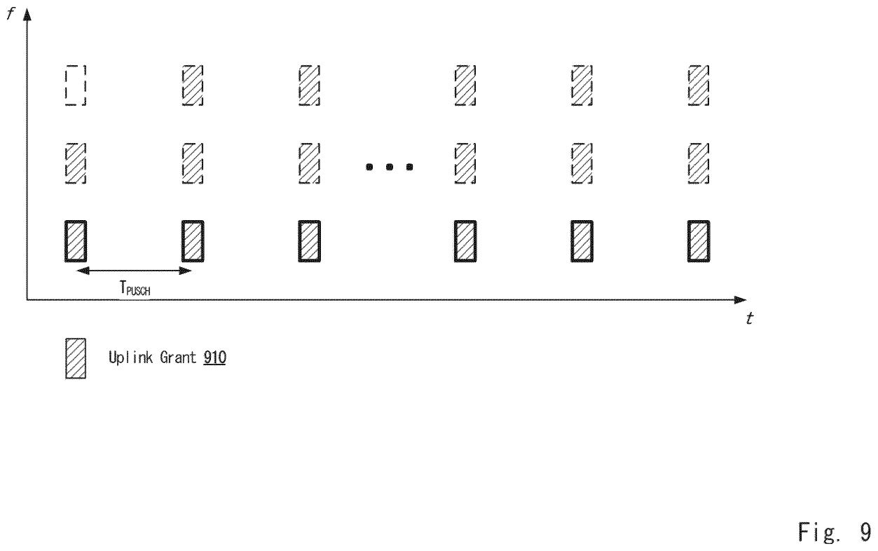

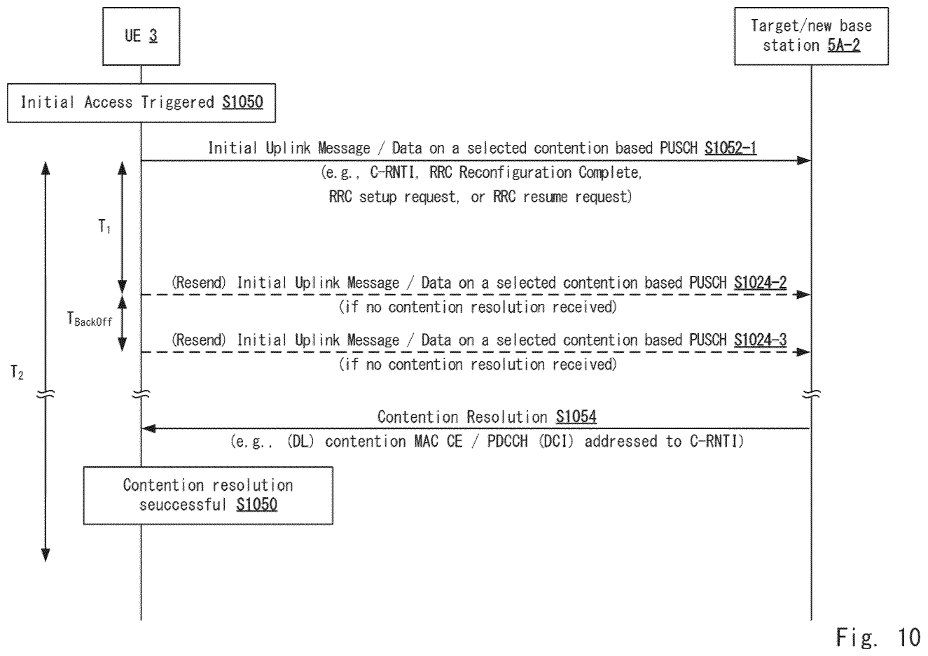

Alternatively, the UE 3 may send an RRC reconfiguration complete message (at S830-2) using a PUSCH with a contention-based PUSCH if configured (e.g., as mentioned above and as described in more detail below with reference to FIGS. 9 and 10).

It will be appreciated that any of the timings referred to above in the context of dynamic grant may also be used by the target base station 5A-2 to determine when a pre-allocated/pre-configured uplink grant may be used.

The target base station 5A-2 will then send, S840 a message indicating handover has been successful (e.g. a Handover Success message) to the source base station 5A-1 to inform the source base station 5A-1 that the UE 3 has successfully accessed the target cell. The source base station 5A-1 can then, if necessary, send (at S842-x) a message to cancel handover (e.g. a Handover Cancel message) for any other candidate cells of the target base station 5A-2, and/or of any other candidate base station 5A-x, to cancel the CHO for the UE 3 at that candidate base station 5A-x.

### RACH-Less Initial Access Using Contention Based PUSCH

As mentioned above, the UEs 3 and RAN 5 of the communication system 1 may be mutually configured for performing RACH-less initial access using a contention based PUSCH.

It will be appreciated that while the RACH-less initial access procedure using a contention based PUSCH is described, primarily in the context of initial access in a target cell after a CHO, a similar initial access procedure could be used for initial access procedure during other mobility/cell change procedures including conventional handover and/or L1/L2 triggered mobility (LTM). Moreover, the contention-based PUSCH may also be used beneficially during an access procedure to form an initial connection in a cell (e.g., RRC connection setup) and/or to resume such a connection (e.g., RRC connection resume).

Use of such a contention based PUSCH for initial access will now be described, by way of example only, with reference to FIGS. 9 and 10.

FIG. 9 shows a simplified time-frequency diagram illustrating how an uplink grant may be configured for a contention based PUSCH.

As seen in FIG. 9 the resources of the uplink grant for the contention based PUSCH may be configured as a periodical CG in which the uplink resources are available periodically in accordance with a defined/configured periodicity (TPUSCH). Moreover, as seen in FIG. 9, multiple grants may (optionally) be configured in the same one or more time slots (or symbols) but at a different frequency locations. It will also be appreciated that multiple grants could also, potentially, be configured in a single contention-based PUSCH period (TPUSCH), for example, with different associated timings (e.g., using different one or more time slots or symbols relative to the start of each period).

The resources of the uplink grant for the contention based PUSCH may be predefined (e.g., implicitly based on a parameter related to the target cell). The target base station 5-2A may, nevertheless, be able to configure the resources for the contention-based PUSCH to the UE 3 using appropriate signalling. The target base station 5-2A may, for example, be able to configure the resources of the uplink grant for the contention based PUSCH via broadcast system information. The target base station 5-2A may, alternatively or additionally, be able to configure the resources of the uplink grant for the contention based PUSCH using dedicated signalling. It will be appreciated that that the configuration of resources of the uplink grant for the contention based PUSCH may be included in the CHO configuration.

FIG. 10 is a simplified sequence diagram illustrating a RACH-less initial access procedure, using a contention-based PUSCH, that may be used in the communication system of FIG. 2.

As seen in FIG. 10 when, at S1050, initial access to a cell is triggered (e.g. following a CHO, HO, or LTM procedure- or for an initial RRC connection setup/resume), and if RACH-skip/RACH-less initial access is configured at the UE 3 (for the cell for which initial access is being performed), the UE 3 makes, at S1052-1, a first attempt at sending the requisite uplink data/uplink message on a selected contention-based PUSCH. The uplink data may, for example, include a C-RNTI assigned by the target base station 5A-2 for the target cell, and or may be sent using: an RRC reconfiguration complete message (e.g., to confirm the CHO/HO complete); an RRC setup request; and RRC resume request; and or the like.

The UE 3 may re-send, at S1052-2, the uplink data/uplink message using the contention-based periodical PUSCH if a contention resolution message is not received within a first defined/configured time window (T1), then apply a random backoff timer (T_{BackOff}) for retransmission S1052-3 on the following contention-based periodical uplink grant.

The target/new base station 5A-2 may send one or more dedicated uplink grants to the UE 3 if the base station 5A-2 is able to detect contention on the contention-based CG and it is possible to guess which one or more UEs are sending data.

If the UE 3 receives a contention resolution (e.g., at S1054), then contention resolution is deemed successfully completed and the initial access for CHO (or other procedure) is considered complete. The contention resolution may, for example, be indicated by a (DL) contention resolution MAC CE (which may include part, or all, the content of the uplink data/message sent by UE 3 previously—i.e., over the contention-based PUSCH). The contention resolution may, for example, be indicated by any DCI, sent on a PDCCH, that is addressed to the C-RNTI for the UE 3 (e.g., a C-RNTI pre-configured for the target cell).

If, however, the UE 3 does not receive a contention resolution within a second defined/configured time window (T₂), then the 3 UE may fall back to a RACH-based handover procedure or declare a handover failure.

RACH-Less Conditional Handover (with CHO Notification)

As mentioned above, the UEs 3 and RAN 5 of the communication system 1 may be mutually configured for performing a RACH-less CHO procedure in which, when one or more CHO execution conditions are fulfilled (or are going to fulfilled), the affected UE 3 reports to the source base station 5A-1 that the UE 3 is about to execute CHO to a selected target cell, and the source base station 5A-1 informs the target base station 5A-2 of the upcoming CHO.

A possible such procedure will now be described, by way of example only, with reference to FIG. 11, which is a simplified sequence diagram illustrating another RACH-less conditional handover procedure that may be used in the communication system 1. It can be seen that the procedure is generally similar to that of FIG. 8.

Referring to FIG. 11, the CHO procedure in this case concerns a handover of a UE 3 between a source cell of a source base station 5A-1 and a target cell (of potentially plural candidate cells) of a target base station 5A-2. The target base station 5A may be one of a number of candidate base stations (i.e., candidates with the potential to become the target base station 5A-2 for the handover) each of which may operate one or more candidate cells (i.e., candidates with the potential to be the target cell).

Before the CHO procedure starts, the source base station 5A-1 serving and communicating with the UE 3 at S1102 (i.e., the source base station 5A-1 of the CHO), will typically have a UE context for the UE 3 stored. This may include, for example, information regarding roaming and access restrictions which were provided either at establishment of the connection between the UE and the source base station 5A-1 or at the last tracking area update.

The source base station 5A-1 configures measurement procedures to be performed by the UE 3, and the UE 3 reports according to the measurement configuration (at S1112). At some point, the source base station 5A-1 makes a decision to configure the UE 3 for a CHO to handover the UE 3 (at S814), for example based on measurement results received in a measurement report and/or radio resource management (RRM) information.

The source base station 5A-1 therefore proceeds, at S1116-x and/or S1116-2, to send handover a respective request, to request CHO, for each of one or more candidate cells belonging to one or more of the candidate base stations 5A-x, 5A-2 including the target base station 5A-2. A CHO request message is sent for each candidate cell.

While not shown, it will be appreciated that, admission control may be performed by each candidate base station 5A-x, 5A-2. Slice-aware admission control may, for example, be performed if corresponding slice information is sent to that candidate base station 5A-x, 5A-2 and if protocol data unit (PDU) sessions are associated with non-supported slices that candidate base station 5A-x, 5A-2 may reject such a PDU session.

Each candidate base station 5A-x, 5A-2 sends, to the source base station 5A-1, a respective CHO response (e.g., a handover request acknowledge message or the like) for each CHO candidate cell (at S1118-x, S1118-2). Each CHO response includes a configuration for the corresponding CHO candidate cell (e.g., in an RRC reconfiguration message or the like). While not explicitly shown, each candidate base station 5A-x, 5A-2 may be able to configure, as part of the corresponding CHO configuration, RACH-skip/RACH-less based CHO for a corresponding candidate cell (as described with respect to FIG. 8). The RRC reconfiguration message carrying any such CHO configuration for a candidate cell may, for example, a RACH-skip information element (IE) to indicate that RACH should be skipped for any access to that candidate cell should it become the target cell for CHO. A candidate base station 5A-x, 5A-2 that provides a CHO configuration for a candidate cell in which RACH-skip/RACH-less initial access has been configured may also (optionally) configure one or more pre-allocated periodical uplink grants (preconfigured CGs) that the UE 3 can use for the PUSCH carrying the first uplink message (e.g., RRC reconfiguration complete) in that candidate cell in the event that candidate cell becomes the target cell of the CHO procedure.

The source base station 5A-1 sends an RRC reconfiguration message (e.g., an RRCReconfiguration message in 5G systems) to the UE 3 at S1122. The RRC reconfiguration message includes information indicating the configuration for each CHO candidate cell-including (where applicable) that RACH-skip is configured and any one or more pre-allocated periodical uplink grants- and information indicating one or more CHO execution conditions. It will be appreciated that, although not illustrated, the CHO configuration of one or more candidate cells may be followed by other reconfiguration information from the source base station 5A-1.

The UE 3 sends an appropriate RRC reconfiguration complete message (e.g., an RRCReconfigurationCompletion message in 5G systems) to the source base station 5A-1 at S1130-1 (effectively confirming the RRC reconfiguration).

The UE 3 maintains the connection with the source base station 5A-1 after receiving CHO configuration and starts evaluating the CHO execution conditions for one or more candidate cells (e.g., based on measurements performed by the UE 3) at S1124. When the UE 3 determines that one or more measurement results for at least one CHO candidate cell satisfies (or will satisfy) the corresponding CHO execution condition, the UE sends, at S1125, a message (e.g., a CHO notification message) to the source base station 5A-1 to notify the source base station 5A-1 that the UE 3 is about to execute CHO to the target cell. This message identifies the target cell and so the source base station 5A-1 can inform the target base station 5A-2 that there is an impending CHO for the UE 3 (e.g., using a handover notification message or the like).

The UE 3 then detaches from the source base station 5A-1, applies the stored corresponding configuration for that selected candidate cell (which is the target cell of handover), and synchronises to that candidate (target) cell (at S1126).

If the target base station 5A-2 therefore knows that the CHO condition have been (or shortly will be) fulfilled, and so the target base station 5A-2 may, start to dynamically schedule a first/initial uplink grant to the UE 3 that is moving to the target cell (e.g., via a PDCCH carrying appropriate downlink control information (DCI)) at S1128. Where a pre-configured/pre-allocated CG has been configured for the UE 3 to use in the target cell the target base station 5A-2 will also know that the pre-configured/pre-allocated CG is about to be used.

Where RACH-skip/RACH-less initial access has been configured for the candidate cell that becomes the target cell, the UE 3 may therefore engage in a RACH-less initial access procedure with the target base station 5A-2 in which it can send an RRC reconfiguration complete message (at S1130-2) using a PUSCH with a pre-allocated/pre-configured uplink grant (CG) or a dynamically scheduled uplink grant (DG).

The target base station 5A-2 will then send, S1140 a message indicating handover has been successful (e.g. a Handover Success message) to the source base station 5A-1 to inform the source base station 5A-1 that the UE 3 has successfully accessed the target cell. The source base station 5A-1 can then, if necessary, send (at S1142-x) a message to cancel handover (e.g. a Handover Cancel message) for any other candidate cells of the target base station 5A-2, and/or of any other candidate base station 5A-x, to cancel the CHO for the UE 3 at that candidate base station 5A-x.

RACH-less Conditional Handover (with indication of CHO timing to network) As mentioned above, the UEs 3 and RAN 5 of the communication system 1 may be mutually configured for performing a RACH-less CHO procedure in which the UEs 3 are able to calculate a predicted time of leaving a current cell (i.e., serving/source cell) and/or or a predicted time of entering another cell (i.e., neighbouring/target cell), and to report one or more predictions to the source base station 5A-1. The source base station 5A-1 can then forward the reported information to the target base station 5A-2.

A possible such procedure will now be described, by way of example only, with reference to FIG. 12, which is a simplified sequence diagram illustrating a procedure for reporting a predicted cell leaving/entry time, in the context of RACH-less conditional handover procedure, which may be used in the communication system 1.

Referring to FIG. 12, the UE 3 calculates, at S1260, a predicted time that the UE 3 will leave the current serving cell and/or a predicted time that the UE 3 will enter a neighbouring cell. In the case of NTN, the calculation may, for example, be based on the serving satellite's and/or neighbouring satellite's ephemeris, trajectory, and/or coverage information. The UE 3 then reports the predicted time of leaving, and/or the predicted time of entering, to the serving base station 5A-1 at S1262. It will be appreciated that one or more predicted times may be reported as part of a measurement report message before the CHO preparation has commenced (e.g., before a CHO decision has been made by the source base station 5A-1). Alternatively or additionally, one or more predicted times may also be included in an RRC reconfiguration complete message which is used to confirm the CHO configuration. Alternatively or additionally, one or more predicted times may also be included in UE assistance information (e.g. provided as part of the UE Assistance Information procedure defined in section 5.7.4 of 3GPP TS 38.331).

The serving base station 5A-1 then forwards, at S1263 this information to the neighbouring base station 5A-2 that operates the neighbouring cell to which the information relates. This information may, for example, be provided to a candidate/target base station/cell for a CHO or LTM procedure, or a target base station/cell for another handover procedure. It will be appreciated that this information may be forwarded in a handover request (e.g., where one or more predicted times are received earlier such as in a measurement report) and, thus, may be used to assist pre-configuration of the CG for the target cell. Where dynamic scheduling is used, this information may be forwarded later in the procedure.

The recipient base station 5A-2 can then pre-allocate/pre-configure one or more uplink grants and/or decide the time to start any dynamic scheduling for the UE 3 (e.g., as part of the CHO procedure described with reference to FIG. 8). It will be appreciated that one or more pre-allocated/pre-configured uplink grants may be provided with a ‘validity’ time window based on one or more predicted times (e.g., similar to the ‘validity’ time window described in more detail with reference to FIG. 13).

The UE 3 may thus complete a RACH-less CHO/HO procedure with the neighbouring base station 5A-2 as a target base station 5A-2 with the UE 3 using the pre-configured UL grant or dynamically scheduled grant for initial access as S1266, as described more generally with reference to FIG. 8.

### Validity Time for Pre-Allocated UL Grant

As mentioned above, the RAN 5 of the communication system 1 may be configured for configuring a ‘validity’ time window in association with a relevant CHO (or possibly conventional handover) configuration.

A possible procedure in which such a validity time window is configured will now be described, by way of example only, with reference to FIG. 13, which is a simplified sequence diagram illustrating a procedure for configuring a validity time window, in the context of RACH-less conditional handover procedure, which may be used in the communication system 1.

Referring to FIG. 13, the UE 3 commences a CHO (or other handover procedure) with the serving (source) base station 5A-1 at S1370. In the case of CHO this procedure may, for example, commence in the manner described with reference to FIG. 8 (and may involve other candidate base station as described for that procedure).

After the target base station 5A-2 receives a handover request (or handover requests for plural cells) from the source base station 5A-1 (at S1312), the target base station 5A-2 pre-allocates/pre-configures (at S1374) one or more associated uplink grants for one or more candidate/target cells each having a respective ‘validity’ time window during which that uplink grant can be considered valid.

The target base station 5A-2 then sends, to the source base station 5A-1, a response (e.g., a handover request acknowledge message or the like) including an associated RRC reconfiguration (at S818). The RRC reconfiguration includes, in this example, information defining one or more pre-allocated/pre-configured uplink grants in association with information defining one or more associated validity windows. For CHO, a respective response may be sent for each CHO candidate cell including a configuration for the corresponding CHO candidate cell (e.g., in the RRC reconfiguration message or the like). The RRC reconfiguration may include, for example, an indication that RACH-skip/RACH-less based (C)HO is configured for the corresponding cell.

The source base station 5A-1 sends one or more RRC reconfigurations to the UE 3 at S1322 including the information defining one or more pre-allocated/pre-configured uplink grants in association with information defining one or more associated validity windows.

when one or more corresponding CHO execution conditions are fulfilled), with the UE 3 using the pre-configured UL grant at S1376, as described more generally with reference to FIG. 8 subject to the usage being within the validity time window.

If the CHO execution condition fulfilled, but the timing of fulfilment is out of the validity time window, then the UE 3 may be required to fall back to a RACH-based (C)HO procedure (as seen at S1376), use a configured uplink resource for a scheduling request (SR), or release the corresponding CHO configuration.

The time window configured for a pre-allocated/pre-configured uplink grant may, for example, be an independent time window. Alternatively, the time window configured for a pre-allocated/pre-configured uplink grant may, for example, be a relative time window linked to a time window defined by a configuration of a time-based CHO trigger event if the execution condition corresponds to that CHO trigger event. One such event is, for example, the so-called ‘CondEvent T1’ which triggers when a time measured at the UE 3 is within a duration from threshold.

Specifically, for the CondEvent T1 the UE 3 considers the entering condition for this event to be satisfied when a first condition (T1-1) is fulfilled and considers the leaving condition for this event to be satisfied when a second condition (T1-2) is fulfilled. The entering/first condition (T1-1) is defined by the inequality Mt >Thresh1, whereas the leaving/second condition (T1-2) is defined by the inequality Mt >Thresh1+Duration.

The variables in the inequalities are defined as follows:
Mt is the time measured at UE 3 (which may be expressed in ms);
Thresh1 is the threshold parameter for this event (this may be defined by an appropriate IE (e.g., t1-Threshold IE) within a report configuration (e.g., reportConfigNR for 5G) for this event); and
Duration is the duration parameter for this event (this may be defined by an appropriate IE (e.g., duration IE) within the report configuration (e.g., reportConfigNR for 5G) for this event).
   Thresh1 and Duration are expressed in the same unit as Mt.

As mentioned above, this validity time may be applicable in a number of scenarios. For example, the validity time window may be used for a quasi-earth fixed cell case, where the t-Service parameter is normally configured to indicate the time when a cell provided via an NTN quasi-Earth fixed system is going to stop serving the area it is currently covering, and hence the handover time is pre-determined. The validity time window may also be used for an earth-moving cell, in which it is predictable roughly how much time the UE 3 will stay in the current cell before handover happens, and/or the validity time may be determined based observed handover frequency. A network may also be able to base the validity time window based on a network-side prediction of the timing of a next handover of a UE 3, for example using an appropriate artificial intelligence/machine learning (AI/ML) algorithm.

### Satellite Switch (Changing PCIs)

As mentioned above, the UEs 3 and RAN 5 of the communication system 1 may also be mutually configured for performing a simplified RACH-less procedure (i.e., without performing all the steps normally considered necessary for a (layer 3 (L3) handover procedure) in the event of a satellite switch occurring.

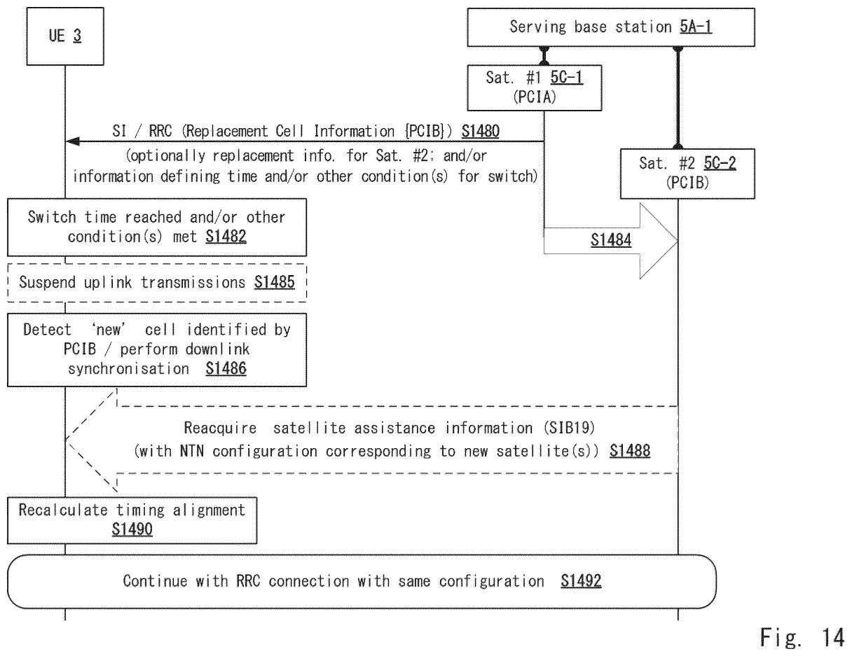

A possible such procedure will now be described, by way of example only, with reference to FIGS. 14 to 16.

FIG. 14 is a simplified sequence diagram illustrating a first simplified RACH-less procedure, which may be used in the communication system 1, in the event of a satellite switch occurring in which PCI is changed.

As seen in FIG. 14, the UE 3 is initially in a cell of a serving base station 5A-1, that is being provided via a first satellite (or other non-terrestrial platform) 5C-1 and has a first associated PCI (PCIA). While in this cell the UE 3 receives, at S1480, replacement cell information from the serving base station 5A-1 that will, ultimately, be used to replace the corresponding cell related information for the cell in which the UE 3 is located when the satellite/service link changes to a second satellite 5C-2. It will be appreciated that this replacement cell information can be thought of conceptually either as information relating to a ‘replacement’ cell (i.e., a cell that replaces the current cell) on satellite switch, or as ‘replacement’ information (i.e., information that replaces current information) for the same serving c ell on satellite switch.

In this example, as the PCI will change on satellite switch, the replacement cell information includes at least the new PCI (PCIB) that will be used for the serving cell after the satellite/service link changes to the second satellite 5C-2. The replacement cell information may also include replacement satellite information (e.g., NTN configuration information relating to the second satellite 5C-2 as described with reference to FIG. 4). The replacement cell information may also include information defining the time and/or some other condition that indicates when replacement will be considered to have happened.

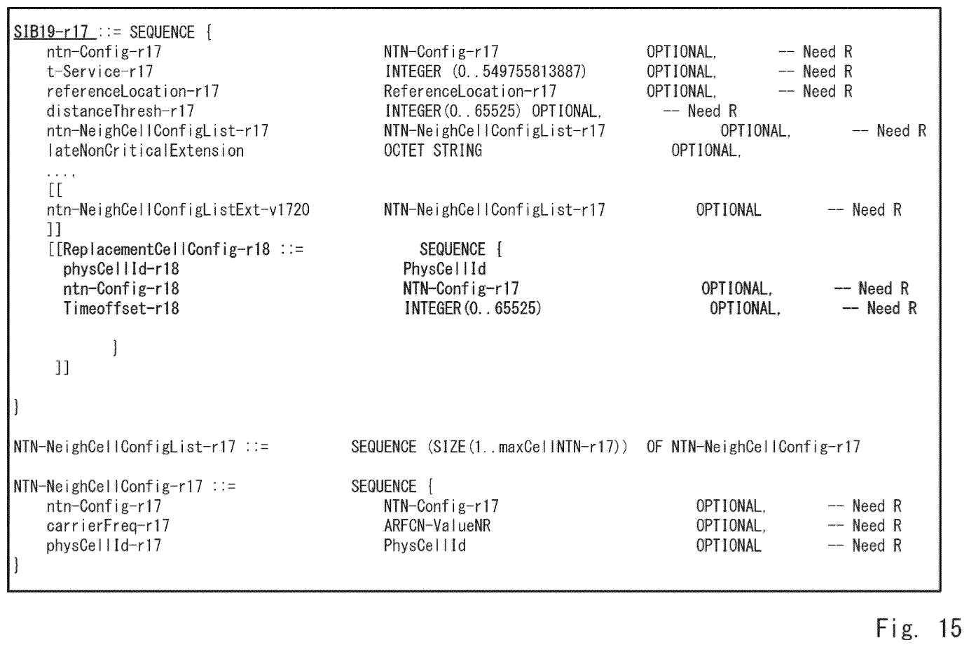

The replacement cell information may, for example, be provided as part of broadcast information related to the current satellite, for example, as part of satellite assistance information for the current satellite provided in system information (e.g. in SIB19). FIG. 15 shows, by way of example only, an abstract syntax notation one (ASN.1) definition of a data structure for a system information block that may be used in the procedure of FIG. 14. In this example, the t-Service-r17 IE may be (re) used to indicate the timing that the switch will happen and/or the format of the ntn-Config IE-r17 may be (re) used for the new NTN configuration (e.g., as an ntn-Config-r18 IE) corresponding to the replacement satellite at the time of the switch.

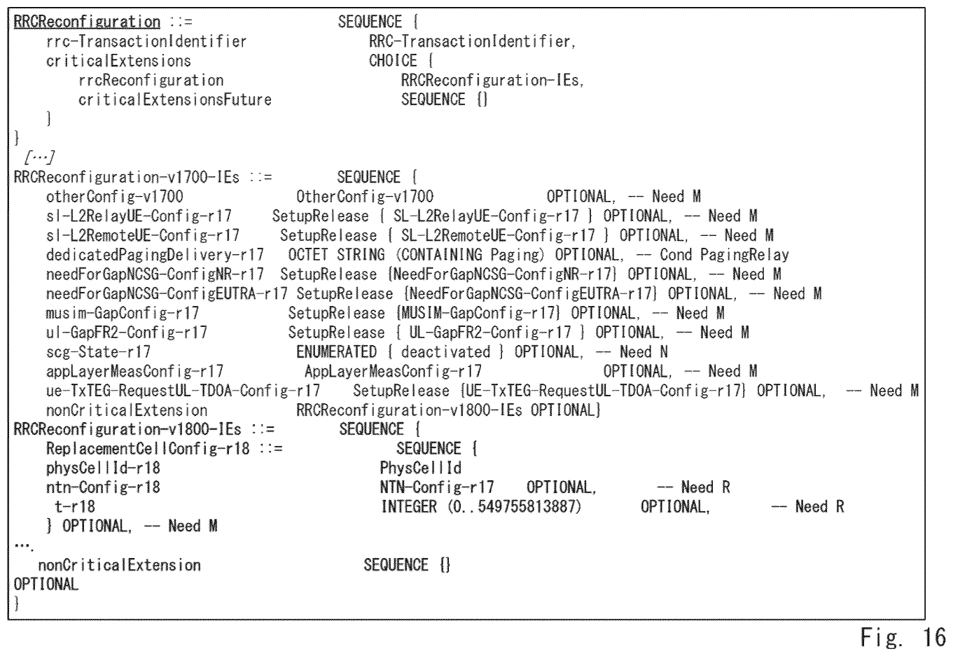

The replacement cell information may, for example, be provided via dedicated signalling, e.g., in an RRC reconfiguration message. FIG. 16 shows, by way of example only, an abstract syntax notation one (ASN.1) definition of a data structure for an RRC reconfiguration message that may be used in the procedure of FIG. 14. In this example, a new IE may be added (e.g., t-r18) to indicate the switch timing. Nevertheless, the t-Service indication (e.g., provided in SIB19) may be (re) used.

As seen at S1482, at the indicated time (or when some other defined condition has been met), the UE 3 detaches from the serving cell as identified by the first PCI (PCIA). At around the same time the satellite switch to the second satellite 5C-2 occurs and the serving (‘replacement’) cell starts to be provided via the second satellite 5C-2.

The UE 3 may then consider that uplink synchronization has been lost and hence suspend all uplink transmissions at S1485.

The UE 3 can then search for and detect the ‘new’ cell as identified by the second PCI (PCI B) and perform downlink synchronisation to it at S1486.

The UE 3 may (re) acquire, at S1488, satellite assistance information (e.g., SIB19) within which NTN configuration information (e.g., NTN-config IE), corresponding to the replacement satellite and cell information, should be present. This step is optional but is particularly beneficial if the replacement satellite information is not configured together with the satellite information for the previous satellite as S1480.

The UE 3 can recalculate the timing alignment based on the information for the replacement satellite 5C-2, and any other necessary information indicated by the NTN configuration corresponding to the new satellite 5C-2. Then UE 3 may continue on the assumption that uplink synchronization has been obtained.

Thus, the UE 3 can continue, as S1492, with the RRC connection using the same configuration and, beneficially, neither RACH nor L3 mobility (including key change) is needed.

If, for any reason, the UE 3 cannot detect the cell identified by PCI B, the UE 3 may fall back to a radio-link failure (RLF)/RRC re-establishment procedure.

It will be appreciated that this procedure is applicable for either be a hard switch (in which the old cell disappears followed by the new cell appearing) or a soft switch (in which the old cell disappears after the new cell appears).

### Satellite Switch (Unchanging PCI)

As mentioned above, the UEs 3 and RAN 5 of the communication system 1 may also be mutually configured for performing another simplified RACH-less procedure (i.e., without performing all the steps normally considered necessary for a (layer 3 (L3) handover procedure) in the event of a satellite switch occurring.

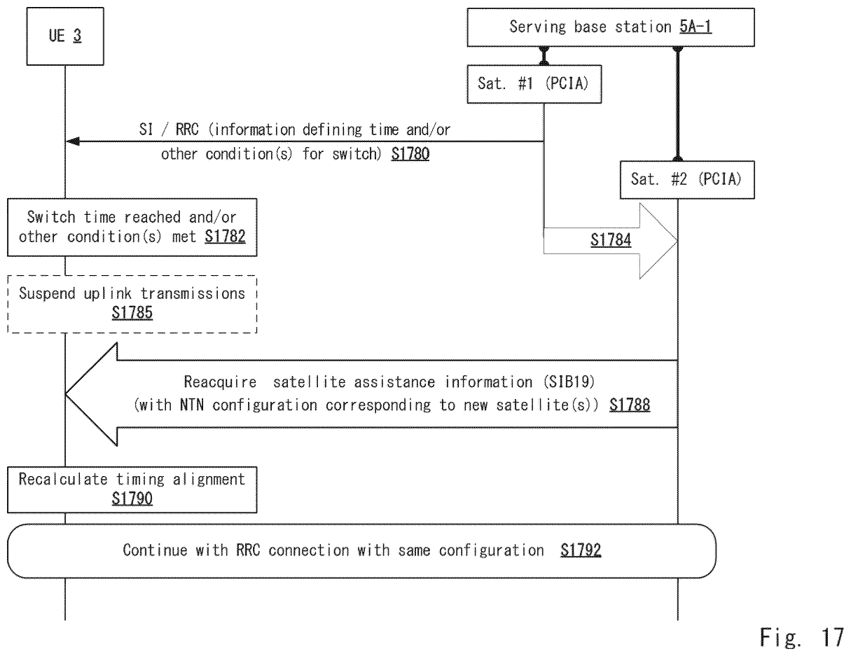

A possible such procedure will now be described, by way of example only, with reference to FIG. 17.

FIG. 17 is a simplified sequence diagram illustrating a first simplified RACH-less procedure, which may be used in the communication system 1, in the event of a satellite switch occurring in which PCI is not changed.

As seen in FIG. 17, the UE 3 is initially in a cell of a serving base station 5A-1, that is being provided via a first satellite (or other non-terrestrial platform) 5C-1 and has an associated PCI (PCIA). While in this cell the UE 3 receives, at S1780, information defining the time and/or some other condition that indicates when replacement will be considered to have happened.

The information may, for example, be provided as part of broadcast information related to the current satellite, for example, as part of satellite assistance information for the current satellite provided in system information (e.g. in SIB19). The time indicated by the t-Service IE may, for example, be (re) used in this procedure as defining the time when satellite switch will happen. The replacement cell information may, nevertheless, be provided via dedicated signalling, e.g., in an RRC reconfiguration message.

As seen at S1782, at the indicated time (or when some other defined condition has been met), the satellite switch to the second satellite 5C-2 occurs and the serving (‘replacement’) cell (also identified by PCIA in this example) starts to be provided via the second satellite 5C-2.

The UE 3 may consider that uplink synchronization has been lost and hence suspend all uplink transmissions at S1785.

The UE 3 then (re) acquires, at S1788, satellite assistance information (e.g., SIB19) within which NTN configuration information (e.g., NTN-config IE), corresponding to the replacement satellite and cell information, should be present.

The UE 3 can recalculate the timing alignment based on the information for the replacement satellite 5C-2, and any other necessary information indicated by the NTN configuration corresponding to the new satellite 5C-2. Then the UE 3 may continue on the assumption that uplink synchronization has been obtained.

Thus, the UE 3 can continue with the RRC connection using the same configuration and, beneficially, neither RACH nor L3 mobility (including key change) is needed.

### User Equipment

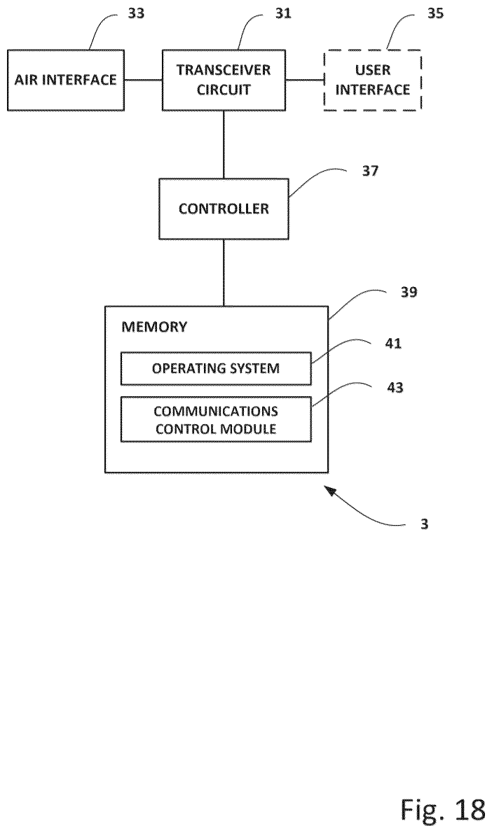

FIG. 18 is a simplified block schematic illustrating the main components of a UE 3 for implementation in the system of FIG. 2.

As shown, the UE 3 comprises transceiver circuitry 31 that is operable to transmit signals to and to receive signals from a RAN 5 via an air interface 33 and one or more antennas.

The UE 3 has a controller 37 to control the operation of the UE 3. The controller 37 is associated with a memory 39 and is coupled to the transceiver circuit 31. Although not necessarily required for its operation, the UE 3 might, of course, have all the usual functionality of a conventional UE 3 (e.g. a user interface 35, such as a touch screen/keypad/microphone/speaker and/or the like for, allowing direct control by and interaction with a user) and this may be provided by any one or any combination of hardware, software and firmware, as appropriate.

The controller 37 is configured to control overall operation of the UE 3 by, in this example, program instructions or software instructions stored within the memory 39. The software may be pre-installed in the memory 39 and/or may be downloaded via the communication system or from a removable data storage device (RMD), for example. As shown, these software instructions include, among other things, an operating system 41 and a communications control module 43.

The communications control module 43 is operable to control the communication between the UE 3 and its one or more serving RANs 5 (and other communication devices connected to the RAN 5, such as further UEs and/or core network nodes). The communications control module 43 is configured for the overall handling of uplink communications via associated uplink channels (e.g. via a physical uplink control channel (PUCCH), random access channel (RACH), and/or a physical uplink shared channel (PUSCH)) including both dynamic and semi-static signalling (e.g., SRS). The communications control module 43 is also configured for the overall handling receipt of downlink communications via associated downlink channels (e.g. via a physical downlink control channel (PDCCH) and/or a physical downlink shared channel (PDSCH)) including both dynamic and semi-static signalling (e.g., CSI-RS, SSBs etc.).

The communication control module 43 is responsible, for example, for controlling the part played by the UE 3 in procedures such as the reception of measurement control/configuration information, reception of system information, RRC signalling, mobility procedures, implementing appropriate timing advances to compensate for timing misalignments etc.

The communications control module 43 controls, for example, the UE's role in the performance of initial access procedures (RACH and RACH-less) to connect to a base station 5A, and mobility procedures including conditional and other handover procedures and other procedures in which the serving cell changes (or appears to change).

It will be appreciated that the communications control module 43 may include a number of sub-modules (or ‘layers’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

### Base Station

FIG. 18 is a simplified block schematic illustrating the main components of a base station 5A for implementation in the system of FIG. 2 (e.g. in an NTN access network or other such RAN 5).

As shown, the base station 5A comprises transceiver circuitry 51 that is operable to transmit signals to and to receive signals from UEs 3 via an air interface 53 and one or more antennas (e.g. of the gateway 9 or non-terrestrial platform 11). The transceiver circuitry 51 is also operable to transmit signals to and to receive signals from functions of the core network 7 and/or other base stations 5A via a network interface 55. The network interface typically includes an N1, N2 and/or N3 interfaces for communicating with the core network and a base station to base station (e.g. Xn) interface for communicating with other base stations.

The base station 5A also comprises a controller 57 which controls the operation of the transceiver circuitry 51 in accordance with software stored in memory 59. The software may be pre-installed in the memory 59 and/or may be downloaded via the communications network 1 or from a removable data storage device (RMD), for example. The software includes, among other things, an operating system 61 a communications control module 63.

The communications control module 63 is operable to control the communication between the base station 5A and the UEs 3 and between the base station 5A and other network entities that are connected to the base station 5A. For example, the communications control module 63 controls the part played by the base station 5A in the flow of uplink and downlink user traffic and of control data to be transmitted to one or more UEs 3 served by the base station 5A including, for example, control data for managing operation of the UEs 3. The communication control module 63 is responsible, for example, for the overall handling of the reception and decoding of uplink communications, via associated uplink channels (e.g. via a physical uplink control channel (PUCCH), a random-access channel (RACH), and/or a physical uplink shared channel (PUSCH)) including both dynamic and semi-static signalling (e.g., SRS). The communication control module 63 is also responsible, for example, for the overall handling of the transmission of downlink communications via associated downlink channels (e.g. via a physical downlink control channel (PDCCH) and/or a physical downlink shared channel (PDSCH)) including both dynamic and semi-static signalling (e.g., CSI-RS, SSBs etc.).

The communication control module 63 is responsible, for example, for controlling the part played by the base station 5A in procedures such as the communication of measurement control/configuration information, the broadcast of system information, RRC signalling, mobility procedures, determining and signalling appropriate timing advances to compensate for timing misalignments etc.

The communication control module 63 is responsible, for example, for controlling the part played by the base station 5A in the performance of initial access procedures (RACH and RACH-less) to connect to a UE 3, and mobility procedures including conditional and other handover procedures and other procedures in which the serving cell changes (or appears to change).

It will be appreciated that the communications control module 63 may include a number of sub-modules (or ‘layers’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

Various methods that may be used in the system 1 will now be described, by way of example only.

### Modifications and Alternatives

A detailed example embodiment has been described above. As those skilled in the art will appreciate, a number of modifications and alternatives can be made to the above example embodiments whilst still benefiting from the disclosure embodied therein.

It will be appreciated that description of features of and actions performed by a base station (or gNB), NTN nodes, and UEs may be applied equally to base stations and UEs that communicate in the terrestrial plane only (i.e. as part of a terrestrial RAN without features of an NTN RAN such as a gateway and space or airborne platform) as to base stations that communicate via a non-terrestrial plane.

Moreover, description of features of and actions performed by a base station (or gNB) apply equally to distributed type base stations as to non-distributed type base stations.

It will also be appreciated that whilst information elements having specific names have been described differently named information elements but having a similar purpose may be used.

In the above description the UE and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied to the UE or base station as a signal over a computer network, or on a recording medium. Further, the functionality performed by part, or all, of this software may be performed using one or more dedicated hardware circuits. However, the use of software modules is preferred as it facilitates the updating of the UE or the base station in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for an extended period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; moulds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IOT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for an extended period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Further, the above-described UE categories are merely examples of applications of the technical ideas and example embodiments described in the present document. Needless to say, these technical ideas and example embodiments are not limited to the above-described UE and various modifications can be made thereto.

Each feature disclosed in this specification (which term includes the claims) and/or shown in the drawings may be incorporated in the disclosure independently of (or in combination with) any other disclosed and/or illustrated features where it is technically feasible to do so. In particular but without limitation the features of any of the claims dependent from a particular independent claim may be introduced into that independent claim in any combination or individually wherever doing so does not cause a technically incompatibility or result in something that does not make technical sense.

Various other modifications will be apparent to those skilled in the art and will not be described in further detail here.

For example, the whole or part of the exemplary embodiments disclosed above can be described as, but not limited to, the following supplementary notes.

### (Supplementary Note 1)

A method performed by a candidate access network node, the method comprising:
receiving, from a serving access network node, at least one message for requesting preparation for a conditional handover, for a user equipment (UE), from a serving cell of the serving access network node, to at least one candidate cell of the candidate access network node, wherein the at least one candidate cell is a candidate to be a target cell for the conditional handover and the candidate access network node is a candidate to be a target access network node for the conditional handover; and
transmitting, to the serving access network node, at least one message including configuration information for the conditional handover to the at least one candidate cell;
wherein the configuration information includes information indicating that, in a case where the UE performs an access procedure to access the at least one candidate cell, the access procedure is to be performed without using a random access channel.

### (Supplementary Note 2)

A method according to supplementary note 1, further comprising, scheduling at least one resource for uplink communication for use by the UE in the access procedure; and
in a case where the UE performs the access procedure to access the at least one candidate cell:
receiving, from the UE, an uplink message that is sent using the at least one resource for uplink communication that has been scheduled by the candidate access network node.

### (Supplementary Note 3)

A method according to supplementary note 2, wherein the uplink message indicates that the conditional handover to the at least one candidate cell has completed at the UE.

### (Supplementary Note 4)

A method according to supplementary note 2 or 3, further comprising receiving, from the serving access network node, a notification that a conditional handover to the at least one candidate cell has been, or will be, initiated; and receiving, based on the notification, the uplink message.

### (Supplementary Note 5)

A method according to supplementary note 4, wherein the receiving, based on the notification, comprises dynamically scheduling the at least one resource for uplink communication and receiving the uplink message using the at least one resource for uplink communication.

### (Supplementary Note 6)

A method according to supplementary note 4, wherein the method further comprises pre-configuring at least one resource for uplink communication prior to reception of the notification, and the receiving, based on the notification, comprises decoding, based on the notification, the uplink message.

### (Supplementary Note 7)

A method according to supplementary note 2, 3, or 4, wherein the scheduling comprises dynamic scheduling of the at least one resource for uplink communication.

### (Supplementary Note 8)

A method according to supplementary note 7, further comprising receiving, from the serving access network node, time information indicating a predicted time that the UE will leave the serving cell and/or a predicted time that the UE will enter the at least one candidate cell, wherein timing of the dynamic scheduling is based on the time information.

### (Supplementary Note 9)

A method according to supplementary note 2, 3, or 4, wherein the scheduling comprises pre-configuring the at least one resource for uplink communication as a configured grant.

### (Supplementary Note 10)

A method according to supplementary note 9, wherein the configured grant is configured specifically for use by the UE for uplink communication in the access procedure for the conditional handover.

### (Supplementary Note 11)

A method according to supplementary note 9, wherein the configured grant is configured for contention based uplink communication.

### (Supplementary Note 12)

A method according to supplementary note 9, or 10, wherein the configuration information for the conditional handover includes scheduling information for configuring the configured grant.

### (Supplementary Note 13)

A method according to supplementary note 12, wherein the configuration information for the conditional handover includes time information for configuring a time period during which the configured grant is valid.

### (Supplementary Note 14)

A method according to supplementary note 13, wherein the time information is configured for configuring the time period during which the configured grant is valid relative to a further time period for a time based condition for triggering the conditional handover.

### (Supplementary Note 15)

A method according to supplementary note 13 or 14, further comprising receiving, from the serving access network node, further time information indicating a predicted time that the UE will leave the serving cell and/or a predicted time that the UE will enter the at least one candidate cell, wherein the time information is based on the further time information.

### (Supplementary Note 16)

A method performed by a serving access network node, the method comprising: transmitting, to at least one candidate access network node, at least one message for requesting preparation for a conditional handover, for a user equipment (UE), from a serving cell of the serving access network node, to at least one candidate cell of the candidate access network node, wherein the at least one candidate cell is a candidate to be a target cell for the conditional handover and the at least one candidate access network node is a candidate to be a target access network node for the conditional handover;
receiving, from the target access network node, at least one message including configuration information for the conditional handover to the at least one candidate cell; and
transmitting, to the UE, the configuration information for the conditional handover;
wherein the configuration information includes information indicating that, in a case where the UE performs an access procedure to access the at least one candidate cell, the access procedure is to be performed without using a random access channel.

### (Supplementary Note 17)

A method according to supplementary note 16, further comprising receiving, from the UE, a first notification that a conditional handover to the at least one candidate cell has been, or will be, initiated; and transmitting, to the candidate access network node, a second notification that a conditional handover to the at least one candidate cell has been, or will be, initiated.

### (Supplementary Note 18)

A method according to supplementary note 16, or 17, further comprising receiving, from the UE, time information indicating a predicted time that the UE will leave the serving cell and/or a predicted time that the UE will enter the at least one candidate cell, and transmitting the time information to the at least one candidate access network node.

### (Supplementary Note 19)

A method performed by a user equipment (UE), the method comprising:
receiving, from a serving access network node, configuration information for a conditional handover from a serving cell of the serving access network node, to at least one candidate cell of at least one candidate access network node, wherein the at least one candidate cell is a candidate to be a target cell for the conditional handover and the at least one candidate access network node is a candidate to be a target access network node for the conditional handover;
wherein the configuration information includes information indicating that, in a case where the UE performs an access procedure to access the at least one candidate cell, the access procedure is to be performed without using a random access channel.

### (Supplementary Note 20)

A method according to supplementary note 17, further comprising, performing the access procedure to access a specific candidate cell of a specific candidate access network node, the access procedure including transmitting, to the specific candidate access network node, an uplink message that is sent using at least one resource for uplink communication that has been scheduled by the specific candidate access network node.

### (Supplementary Note 21)

A method according to supplementary note 17, or 18 further comprising transmitting, to the serving access network node, a notification that a conditional handover to the at least one candidate cell has been, or will be, initiated.

### (Supplementary Note 22)

A method according to supplementary note 17, 18, or 19 further comprising transmitting, to the serving access network node, time information indicating a predicted time that the UE will leave the serving cell and/or a predicted time that the UE will enter the at least one candidate cell.

### (Supplementary Note 23)

A method performed by a user equipment (UE), the method comprising:
transmitting, to an access network node as part of an initial access procedure that does not involve use of a random access channel, an initial uplink message using at least one uplink resource, wherein the at least one uplink resource is a resource configured for contention based uplink communication;
in a case where a contention resolution indication is not received from the access network node within a first time period, resending the initial uplink message to the access network node using the at least one uplink resource;
in a case where a contention resolution indication is received from the access network node within the first time period, treating the initial access procedure as successfully completed in further communication with the access network node; and
in a case where a contention resolution indication is not received from the access network node within a second time period, treating the initial access procedure as not having been successfully completed.

### (Supplementary Note 24)

A method according to supplementary note 23, further comprising in the case where a contention resolution indication is not received from the access network node within the first time period and has still not been received within a third time period starting from the end of the first period, repeating the resending of the initial uplink message to the access network node using the at least one uplink resource.

### (Supplementary Note 25)

A method according to supplementary note 23, or 24, further comprising in the case where a contention resolution indication is not received from the access network node within the second time period, performing a fall-back initial access procedure using a random access channel.

### (Supplementary Note 26)

A method according to supplementary note 23, or 24, or 25, wherein in a case where a contention resolution indication is received from the access network node, the contention resolution indication includes at least some information that was included in the uplink message.

### (Supplementary Note 27)

A method according to any one of supplementary notes 23 to 26, wherein in a case where a contention resolution indication is received from the access network node, the contention resolution indication is provided using a media access control (MAC) control element (CE).

### (Supplementary Note 28)

A method according to any one of supplementary notes 23 to 26, wherein in a case where a contention resolution indication is received from the access network node, the contention resolution indication is provided using downlink control information (DCI).

### (Supplementary Note 29)

A method according to supplementary note 28, wherein the DCI is encoded using a radio network temporary identifier (RNTI) associated with the UE.

### (Supplementary Note 30)

A method performed by an access network node, the method comprising:
receiving, from a user equipment (UE) as part of an initial access procedure that does not involve use of a random access channel, an initial uplink message using at least one uplink resource, wherein the at least one uplink resource is a resource configured for contention based uplink communication;
transmitting a contention resolution indication to the UE; and
treating the initial access procedure as successfully completed in further communication with the UE.

### (Supplementary Note 31)

A method performed by a user equipment (UE), the method comprising:
communicating with an access network node, in a first cell provided by the access network node, via a first non-terrestrial platform, based on a connection configuration;
receiving from the access network node, via the first non-terrestrial platform, cell related information: that will apply in respect of the first cell when the first cell is provided by the access network node via a second non-terrestrial platform following a change of non-terrestrial platform; or that will apply in respect of a second cell provided by the access network node via the second non-terrestrial platform that replaces the first cell following the change of non-terrestrial platform; and
following the change of non-terrestrial platform, preparing for communication via the second non-terrestrial platform based on the cell related information; and continuing communication with the access network node, based on the connection configuration, in the first cell, or in the second cell in a case where the second cell replaces the first cell.

### (Supplementary Note 32)

A method according to supplementary note 31, wherein the cell related information includes a new physical cell identifier (PCI) that will apply in respect of a second cell provided by the access network node via the second non-terrestrial platform that replaces the first cell following the change of non-terrestrial platform.

### (Supplementary Note 33)

A method according to supplementary note 32, further comprising (re) detecting the first cell, or in the second cell in a case where the second cell replaces the first cell, based on the new PCI before continuing communication.

### (Supplementary Note 34)

A method according to supplementary note 31, or 32, wherein the cell related information includes information indicating a time at which, and/or another condition that will be met when, the change of non-terrestrial platform will change.

### (Supplementary Note 35)

A method according to supplementary note 31, 32, or 33, wherein the cell related information includes assistance information for the second non-terrestrial platform.

### (Supplementary Note 36)

A method according to any one of supplementary notes 31 to 35, further comprising acquiring assistance information for the second non-terrestrial platform broadcast via the second non-terrestrial platform before continuing communication.

### (Supplementary Note 37)

A method according to any one of supplementary notes 31 to 36, further comprising temporarily suspending uplink communication before continuing communication.

### (Supplementary Note 38)

A method according to any one of supplementary notes 31 to 37, further comprising recalculating a timing alignment for communication via the second non-terrestrial platform before continuing communication.

### (Supplementary Note 39)

A method performed by an access network node, the method comprising: communicating with a user equipment (UE), in a first cell provided by the access network node, via a first non-terrestrial platform, based on a connection configuration;
transmitting, to the UE, via the first non-terrestrial platform, cell related information: that will apply in respect of the first cell when the first cell is provided by the access network node via a second non-terrestrial platform following a change of non-terrestrial platform; or that will apply in respect of a second cell provided by the access network node via the second non-terrestrial platform that replaces the first cell following the change of non-terrestrial platform; and
continuing communication with the UE, based on the connection configuration, in the first cell, or in the second cell in a case where the second cell replaces the first cell.

### (Supplementary Note 40)

A candidate access network node comprising:
means for receiving, from a serving access network node, at least one message for requesting preparation for a conditional handover, for a user equipment (UE), from a serving cell of the serving access network node, to at least one candidate cell of the candidate access network node, wherein the at least one candidate cell is a candidate to be a target cell for the conditional handover and the candidate access network node is a candidate to be a target access network node for the conditional handover; and
means for transmitting, to the serving access network node, at least one message including configuration information for the conditional handover to the at least one candidate cell;
wherein the configuration information includes information indicating that, in a case where the UE performs an access procedure to access the at least one candidate cell, the access procedure is to be performed without using a random access channel.

### (Supplementary Note 41)

A serving access network node comprising:
means for transmitting, to at least one candidate access network node, at least one message for requesting preparation for a conditional handover, for a user equipment (UE), from a serving cell of the serving access network node, to at least one candidate cell of the candidate access network node, wherein the at least one candidate cell is a candidate to be a target cell for the conditional handover and the at least one candidate access network node is a candidate to be a target access network node for the conditional handover;
means for receiving, from the target access network node, at least one message including configuration information for the conditional handover to the at least one candidate cell; and
means for transmitting, to the UE, the configuration information for the conditional handover;
wherein the configuration information includes information indicating that, in a case where the UE performs an access procedure to access the at least one candidate cell, the access procedure is to be performed without using a random access channel.

### (Supplementary Note 42)

A user equipment (UE) comprising:
means for receiving, from a serving access network node, configuration information for a conditional handover from a serving cell of the serving access network node, to at least one candidate cell of at least one candidate access network node, wherein the at least one candidate cell is a candidate to be a target cell for the conditional handover and the at least one candidate access network node is a candidate to be a target access network node for the conditional handover;
wherein the configuration information includes information indicating that, in a case where the UE performs an access procedure to access the at least one candidate cell, the access procedure is to be performed without using a random access channel.

### (Supplementary Note 43)

A user equipment (UE) comprising:
means for transmitting, to an access network node as part of an initial access procedure that does not involve use of a random access channel, an initial uplink message using at least one uplink resource, wherein the at least one uplink resource is a resource configured for contention based uplink communication; means for, in a case where a contention resolution indication is not received from the access network node within a first time period, resending the initial uplink message to the access network node using the at least one uplink resource;
means for, in a case where a contention resolution indication is received from the access network node within the first time period, treating the initial access procedure as successfully completed in further communication with the access network node; and
means for, in a case where a contention resolution indication is not received from the access network node within a second time period, treating the initial access procedure as not having been successfully completed.

### (Supplementary Note 44)

An access network node comprising:
means for receiving, from a user equipment (UE) as part of an initial access procedure that does not involve use of a random access channel, an initial uplink message using at least one uplink resource, wherein the at least one uplink resource is a resource configured for contention based uplink communication;
means for transmitting a contention resolution indication to the UE; and
means for treating the initial access procedure as successfully completed in further communication with the UE.

### (Supplementary Note 45)

A user equipment (UE) comprising:
means for communicating with an access network node, in a first cell provided by the access network node, via a first non-terrestrial platform, based on a connection configuration;
means for receiving from the access network node, via the first non-terrestrial platform, cell related information: that will apply in respect of the first cell when the first cell is provided by the access network node via a second non-terrestrial platform following a change of non-terrestrial platform; or that will apply in respect of a second cell provided by the access network node via the second non-terrestrial platform that replaces the first cell following the change of non-terrestrial platform; and
means for following the change of non-terrestrial platform, preparing for communication via the second non-terrestrial platform based on the cell related information; and
means for continuing communication with the access network node, based on the connection configuration, in the first cell, or in the second cell in a case where the second cell replaces the first cell.

### (Supplementary Note 46)

An access network node comprising:
means for communicating with a user equipment (UE), in a first cell provided by the access network node, via a first non-terrestrial platform, based on a connection configuration;
means for transmitting, to the UE, via the first non-terrestrial platform, cell related information: that will apply in respect of the first cell when the first cell is provided by the access network node via a second non-terrestrial platform following a change of non-terrestrial platform; or that will apply in respect of a second cell provided by the access network node via the second non-terrestrial platform that replaces the first cell following the change of non-terrestrial platform; and
means for continuing communication with the UE, based on the connection configuration, in the first cell, or in the second cell in a case where the second cell replaces the first cell.

This application is based upon and claims the benefit of priority from Great Britain Patent Application No. 2305109.7, filed on Apr. 5, 2023, the disclosure of which is incorporated herein in its entirety by reference.

### REFERENCE SIGNS LIST

1 COMMUNICATION SYSTEM
3 USER EQUIPMENT
5 BASE STATION
5b DISTRIBUTED UNIT (DU)
5c CENTRAL UNIT (CU)
7 CORE NETWORK
9 CELL
10 CONTROL PLANE FUNCTIONS
11 USER PLANE FUNCTIONS
20 EXTERNAL DATA NETWORK
31 TRANSCEIVER CIRCUIT
33 ANTENNA
35 USER INTERFACE
37 CONTROLLER
39 MEMORY
41 OPERATING SYSTEM
43 COMMUNICATIONS CONTROL MODULE
51 TRANSCEIVER CIRCUIT
53 AIR INTERFACE
55 CORE NETWORK INTERFACE
57 CONTROLLER
10 59 MEMORY
61 OPERATING SYSTEM
63 COMMUNICATIONS CONTROL MODULE

What is claimed is:

1-20. (canceled)

21. A method performed by a mobile device, the method comprising:
performing a conditional handover procedure with an access network node, without using a random access channel, and using a configured resource only valid in a configured time window.

22. The method according to claim 21, wherein
the configured time window is configured per conditions for triggering the performing the conditional handover procedure.

23. The method according to claim 21, further comprising:
in a case a timing of performing the conditional handover procedure is out of the configured time window:
performing an initial access procedure with a random access channel, or
performing a scheduling request.

24. The method according to claim 21, wherein
the configured resource includes a contention-based periodically configured grant, and
the performing the conditional handover procedure includes transmitting data on the contention-based periodically configured grant,
the method comprises, in a case where the mobile device does not receive a contention response upon the transmitting the data:
re-transmitting the data,
performing the initial access procedure with a random access channel, or
declaring a failure.

25. The method according to claim 24, further comprising:
receiving contention resolution in response to the transmitting the data, and
wherein the contention resolution includes at least one of:
a Media Access Control (MAC) Control Element (CE) including at least a part of the data, or
a physical downlink channel (PDCCH) corresponding to a Radio Network Temporary Identifier (RNTI) of the mobile device.

26. The method according to claim 24, further comprising:
receiving information for configuring the contention-based periodically configured grant in:
a system information block, or
a Radio Resource Control (RRC) message.

27. The method according to claim 21, wherein
the performing the conditional handover procedure is performed by:
transmitting, to a further access network node configured to a serving cell of the mobile device, information to forward to the access network node, the information indicating at least one of:
a condition of a conditional handover from the further access network node to the access network node is fulfilled, or
a timing when the mobile device will access to a target cell which is operated by the further access network node or the mobile device will leave the serving cell operated by the access network node;
receiving, from the access network node, information for allocating the resource to the mobile device, in response to the transmitting the information; and
accessing to the access network node using the resource.

28. A method performed by an access network node, the method comprising:
performing a conditional handover procedure with a mobile device, without using a random access channel, and using a configured resource only valid in a configured time window.

29. A mobile device comprising:
at least one memory storing instructions; and
at least one processor configured to process the instructions to:
perform a conditional handover procedure with an access network node, without using a random access channel, and using a configured resource only valid in a configured time window.

30. An access network node comprising:
at least one memory storing instructions; and
at least one processor configured to process the instructions to:
perform a conditional handover procedure with a mobile device, without using a random access channel, and using a configured resource only valid in a configured time window.
